(19) United States
(12) Patent Application Publication
(10) Pub. No.: US 2023/0275812 A1
(43) Pub. Date: Aug. 31, 2023

(54) SLICE BY SLICE AI/ML MODEL INFERENCE OVER COMMUNICATION NETWORKS

(71) Applicant: InterDigital CE Patent Holdings, SAS, Paris (FR)

(72) Inventors: Thierry FILOCHE, Cesson-Sevigne (FR); Cyril QUINQUIS, Cesson-Sevigne (FR); Patrick FONTAINE, Cesson-Sevigne (FR); Pascal LE GUYADEC, Cesson-Sevigne (FR); Anne LAMBERT, Cesson-Sevigne (FR); Francois SCHNITZLER, Cesson-Sevigne (FR)

(21) Appl. No.: 18/020,215

(22) PCT Filed: Jul. 16, 2021
(86) PCT No.: PCT/EP2021/069944

§ 371 Date: Feb. 7, 2023

(30) Foreign Application Priority Data
Aug. 10, 2020 (EP) 20305921.7
Aug. 10, 2020 (EP) 20305922.5

(51) Int. Cl. H04L 41/16; G06N 3/045; G06N 3/082

(52) U.S. Cl. CPC H04L 41/16; G06N 3/045; G06N 3/082

(57) ABSTRACT

In one implementation, the AI/ML model is first split into several unitary chunks that correspond to sub-parts of the model. Then an aggregation of unitary chunks is made by considering the download time, inference time of unitary chunks, and/or device constraints. The first split corresponds to a first chunk of AI/ML layers that, once downloaded, is useable as is, and generates intermediate results based on some sensing/perception data. As soon as a new chunk arrives, it is used to generate new results based on the intermediate data of the previous chunk. Since download and inference are parallelized, a final result can be generated earlier than with the full sequential method. In addition, as soon as the inference ends on a chunk, this chunk may be removed from the device. Several AI/ML model split methods are provided to generate model subsets/chunks for different model architectures.

### FIELD

Embodiments disclosed herein generally relate to wireless communications and, for example to methods, apparatus and systems for AI/ML model inference over communication networks.

### BACKGROUND

A deep neural network (DNN) is a complex function mapping some input domain to another domain, the output. A DNN is composed of several neural layers (typically in series) and each neural layer is composed of several perceptrons. A perceptron is a function that consists of a linear combination of the inputs and a non-linear function, for example a sigmoid function.

Therefore, a DNN is composed of two elements: the architecture, that includes the number of perceptrons and the connections between them, and the parameters, which are the weights of the linear functions and, if required, the parameters of the non-linear functions.

Trained by a machine learning algorithm on huge data sets, these models have recently proven useful for a wide range of applications and have led to significant improvements to the state-of-the-art in artificial intelligence, computer vision, audio processing and several other domains. Due to their prevalence today, they are often referred to as a “AI/ML model”.

Besides DNN, Decision Trees and Random Forest are other examples of machine learning techniques that could be considered. Decision Trees are classification and regression methods that can be represented with a root, branches and leaves. Its structure is based on nested if-else conditions called the nodes from which the tree splits into branches. The end of the branch that does not split anymore is the leaf or decision. Decision Tree Learning is applicable to a wide range of domains from medical diagnosis to industry.

Applications rely more and more on AI/ML models running on end users' devices to provide interactive results under strict latency requirements. These AI/ML models are usually located on remote servers, for example, at the edge or in the cloud, and model sizes range from some KBytes to several hundred of Mbytes. Mobile devices will request to download new AI/ML models or newer versions of AI/ML models, typically when launching new services, changing applicative context, or in the context of incremental learning. When requested by an application, the end user will have to wait for the full download of the model before the inference runs with the input data. Another drawback is that the mobile device needs to load the full model in memory to run the inference, and it is sometimes impossible due to lack of memory or lack of disk space available.

### SUMMARY

According to an embodiment, a method is provided, comprising: splitting an AI/ML model into a plurality of sub-parts; and forming a set of aggregation chunks, each aggregation chunk corresponding to one or more sub-parts of said plurality of sub-parts, based on download time and inference time associated with said plurality of sub-parts.

According to another embodiment, a method is provided, comprising: receiving a chunk that is part of an AI/ML model; generating a first inference or intermediate result from said chunk; receiving a subsequent chunk that is also part of said AI/ML model; and generating an inference result based on said first inference or intermediate result and said subsequent chunk.

According to another embodiment, a server is presented, comprising one or more processors and at least a memory, said one or more processors configured to: split an AI/ML model into a plurality of sub-parts; and form a set of aggregation chunks, each aggregation chunk corresponding to one or more sub-parts of said plurality of sub-parts, based on download time and inference time associated with said plurality of sub-parts.

According to another embodiment, a user device is presented, comprising one or more processors and at least a memory, said one or more processors configured to: receive a chunk that is part of an AI/ML model; generate a first inference or intermediate result from said chunk; receive a subsequent chunk that is also part of said AI/ML model; and generate an inference result based on said first inference or intermediate result and said subsequent chunk.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 2 illustrates a classical device-based inference implementation.

FIG. 3 illustrates that a proposed inference implementation.

FIG. 4 illustrates a workflow for slice by slice AI/ML model inference over communication networks, according to an embodiment.

FIG. 5 illustrates a workflow of the chunk split/aggregation preparation operation, according to an embodiment.

FIG. 6 illustrates another workflow of the chunk split/aggregation preparation operation with an orchestrator (or controller) and client, according to another embodiment.

FIG. 7 illustrates an example where the AI/ML model is partitioned in several unitary chunks.

FIG. 8 illustrates all possibilities of aggregation for a model with four unitary chunks.

FIG. 9 illustrates a generic algorithm that builds the list of all combinations.

FIG. 10 illustrates an example of chronological representation—parallelization of chunk download and inference.

FIG. 11 illustrates an example of the calibration phase call flow.

FIG. 12 illustrates slice by slice AI model inference service call flow when the model split is under AI/ML model server control, according to an embodiment.

FIG. 13 illustrates slice by slice AI model inference service call flow when the model split is under UE control, according to an embodiment.

FIG. 14 illustrates an example that the client sends sequentially a download request and makes the inference.

FIG. 15 illustrates an example that the client sends a download request and makes the inference of each chunk as soon as the chunk is downloaded.

FIG. 16 illustrates that when the inference is made on a chunk, the client side can delete the chunk.

FIG. 17 illustrates where C3_1, C3_2, and C3_3 are the first, second and third chunks, respectively, of combination 3, and where C4_1, C4_2, C4_3 and C4_4 are the first, second, third, fourth chunks, respectively, of combination 4.

FIG. 18 illustrates an initial schedule of combinations 3 and 4 with the expected initial bitrate.

FIG. 19 illustrates the updated schedule of combinations 3 and 4 with the revised effective bitrate.

FIG. 20 illustrates the schedule switch between combinations 3 and 4 due to dynamic bitrate reevaluation.

FIG. 21 illustrates an initial schedule of combinations 3 and 4 with the expected initial inference.

FIG. 22 illustrates an updated schedule of combinations 3 and 4 with the revised effective inference.

FIG. 23 illustrates the schedule switch between combinations 3 and 4 due to dynamic inference reevaluation.

FIG. 24 shows an example where “unitary chunks” are mapped on “layer”.

FIG. 25 and FIG. 26 show that “aggregation chunk” are the aggregation of one or more “unitary chunks”.

FIG. 27 shows an example model with hierarchical layers.

FIG. 28 shows where unitary chunks are mapped on “layer” or group of layers.

FIG. 29 shows another example of unitary chunks: layers are grouped in blocks having one input and one output.

FIG. 30 and FIG. 31 show examples where aggregation chunk are the aggregation of one or more unitary chunks.

FIG. 32 illustrates that the VGG16 model is split into 22 unitary chunks.

FIG. 33 provides some graphical representations of the results.

FIG. 34 illustrates an example of problem scenario.

FIG. 35 illustrates another example of problem scenario.

FIG. 36 illustrates an overview of an incremental model downloading process, according to an embodiment.

FIG. 37 illustrates an incremental model downloading process at a UE side, according to an embodiment.

FIG. 38 illustrates that the AI/ML model is not seen as a monolithic entity, but as an ensemble of several model chunks.

FIG. 39 illustrates transmission path monitoring, according to an embodiment.

FIG. 40 illustrates incremental AI/ML model downloading with multi-connections, according to an embodiment.

FIG. 41 illustrates a method of generating chunks from CNNs Mixture Model, according to an embodiment.

FIG. 42 illustrates regular AI/ML model download, according to an embodiment.

FIG. 43 illustrates a method of generating chunks from premodel architecture, according to an embodiment.

FIG. 44 illustrates adaptive neural nets with GoogleNet, ResNet50 and Inception-v4, according to an embodiment.

FIG. 45 illustrates a method of generating chunks from the Early-Exit model, according to an embodiment.

FIG. 46 illustrates another method of generating chunks from the Early-Exit model, according to an embodiment.

FIG. 47 illustrates an example of chunk flow.

FIG. 48 illustrates a method of generating chunks from Early Exit, according to an embodiment.

FIG. 49 illustrates a method of generating chunks from a slimmed network, according to an embodiment.

FIG. 50 illustrates a NestDNN example with Four-Capacity model.

FIG. 51 illustrates a method of generating chunks from NestDNN capacity extension to chunks, according to an embodiment.

FIG. 52 illustrates a method of generating chunks from conditional computation to chunks, according to an embodiment.

FIG. 53 illustrates a method of generating chunks from Decision Tree to chunks, according to an embodiment.

### DETAILED DESCRIPTION

### Example Networks for Implementation of the Embodiments

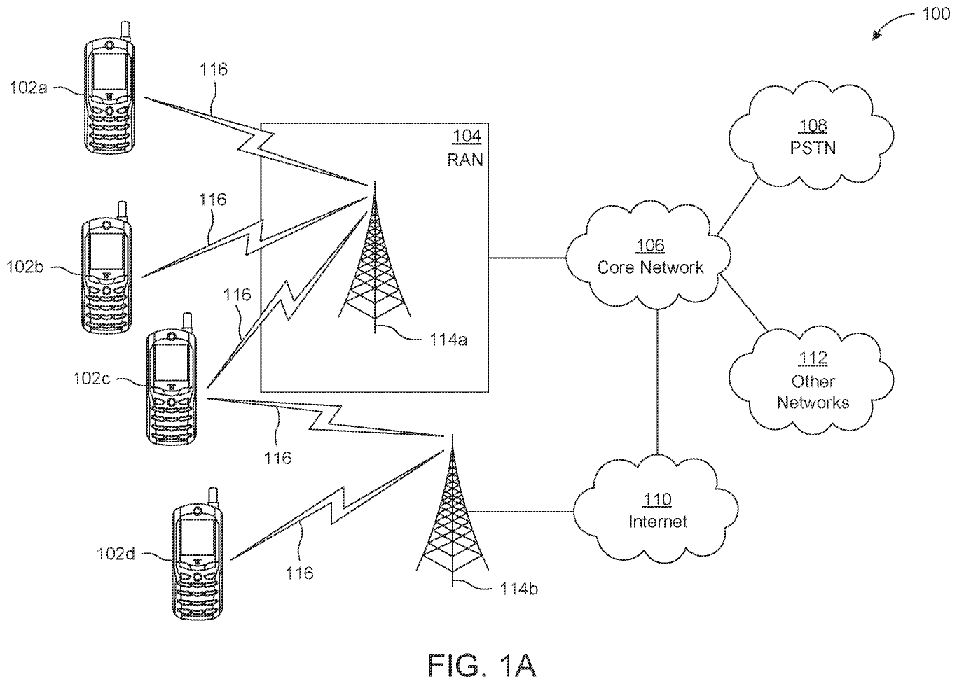

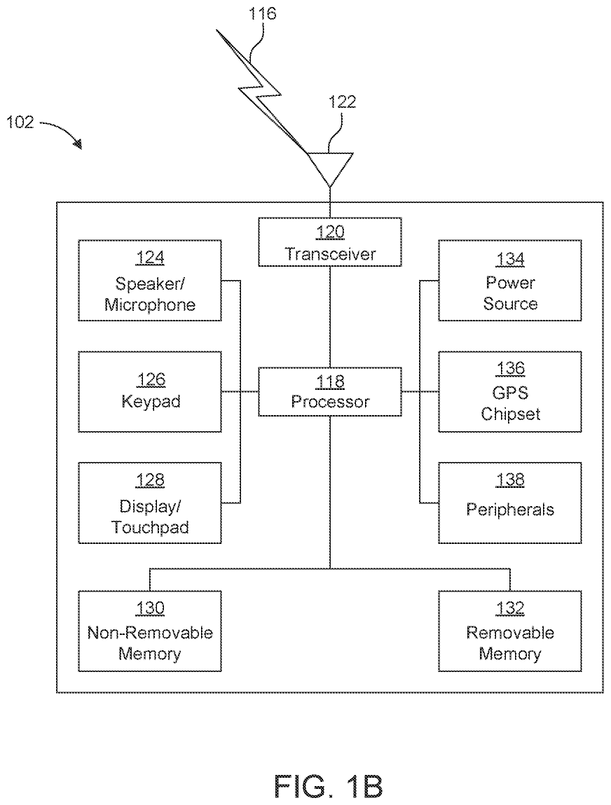

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (end), a Home Node B (HNB), a Home eNode B (HeNB), a gNB, a NR Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an end and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The processor 118 of the WTRU 102 may operatively communicate with various peripherals 138 including, for example, any of: the one or more accelerometers, the one or more gyroscopes, the USB port, other communication interfaces/ports, the display and/or other visual/audio indicators to implement representative embodiments disclosed herein.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

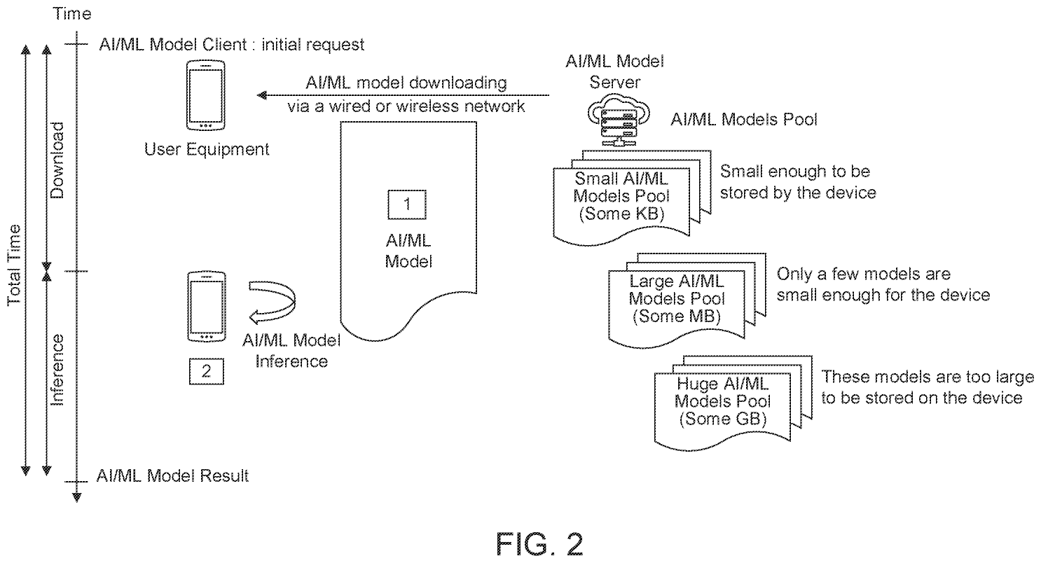

FIG. 2 illustrates a classical device-based inference implementation. A UE requests an AI/ML model from a model server and the downloading of the model starts. Once the download is finished, the AI/ML model is loaded in the UE's memory and the inference is executed.

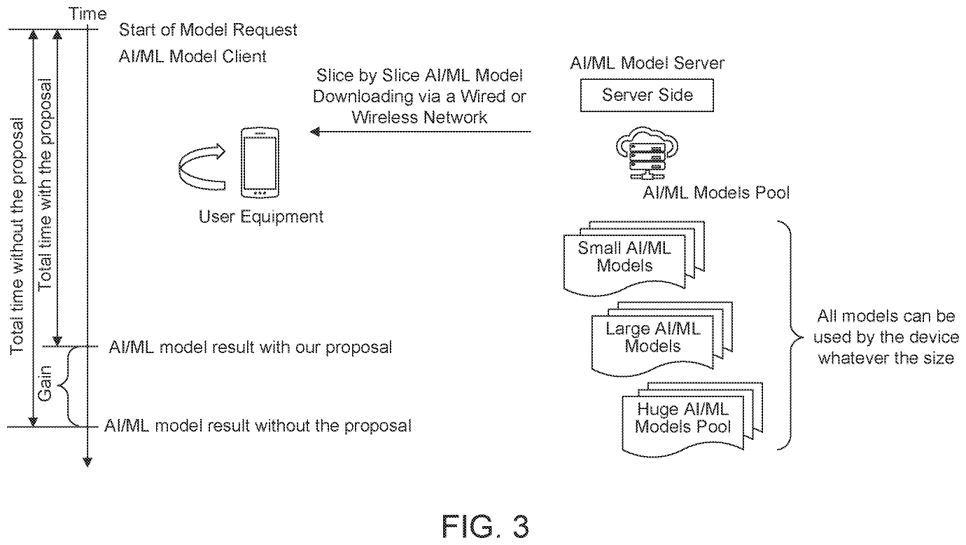

To shorten the total time to get the AI/ML model result, FIG. 3 illustrates a new method. With the new method, the inference on the UE is started before the end of the AI/ML model download, and as a result the final inference result is obtained faster than without the proposed methods. This new method also makes the inference possible even if the device has not enough resources (RAM, disk space) to store the entire model.

In an embodiment, the AI/ML model is first split into several unitary chunks that correspond to sub-parts of the whole AI/ML model (the split considers the model architecture). The “unitary chunks” can be seen as the smallest granularity after splitting a model. These smallest chunks of a model can take some input data and generates output that will be used as input by the next “unitary chunk”. Then an aggregation of these unitary chunks is made following a specific procedure that considers download time, inference time of (aggregation) chunks, and/or device constraints (such as available memory for example). Each aggregation of the unitary chunk is called an “aggregation chunk.” In the followings, a chunk refers to an aggregation chunk unless explicitly specified as unitary chunk. In general, chunks that are transmitted and computed on the UE are aggregation chunks, unitary chunks are smaller split grain and used to build the combination of aggregation chunks. The first split corresponds to a first chunk of AI/ML layers that, once downloaded, is useable as is, and generates intermediate results based on some input data. As soon as a new chunk arrives, it is used to generate new intermediate results based on the intermediate data of the previous chunk.

The proposed techniques have various advantages. For example, they can provide latency reduction, because a user does not need to wait for the sequential time to download AI/ML model, and then the inference time. As soon as the first chunk arrives, following tasks of download and inference are parallelized that gives a final inference result earlier than with the full sequential method. In addition, they may provide device memory saving, because as soon as the inference ends on a chunk, this chunk may be removed from the device on both memory and storage.

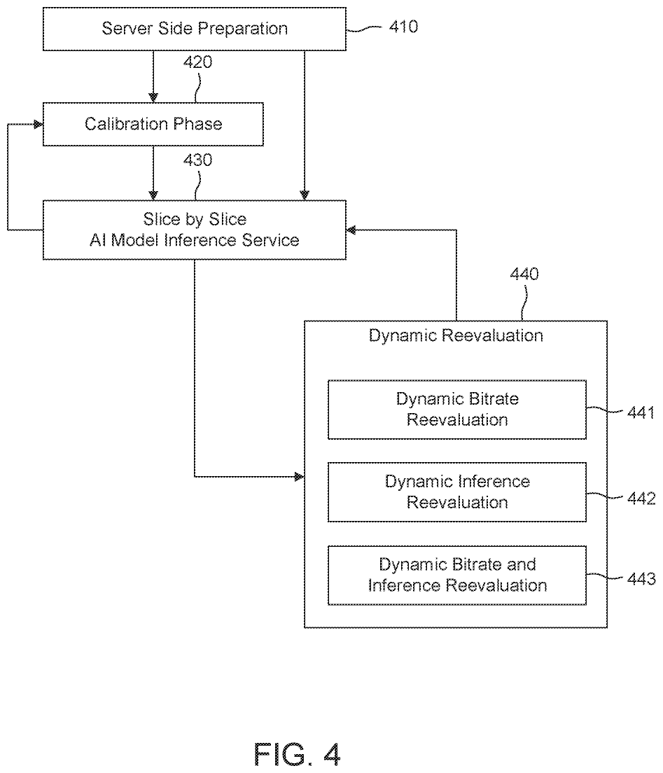

FIG. 4 illustrates a workflow according to an embodiment, which includes the following functionalities or considerations that will be described in detail further below.
Server-side preparation (410)
Exchange between server side and client side
   Calibration phase (420)
   Slice by slice AI model inference service (430). A slice corresponds to an “aggregation chunk” that is made of at least one “unitary chunk”. An “aggregation chunk” may contain multiple “unitary chunks” depending on the selected combination.
Client side
   Use scenario 1: The latency (total time including model download+first inference) is critical for the end user experience (the client can have enough memory to store the full model, i.e., enough memory to store all the chunks)).
   Use scenario 2: The client has NOT enough memory to store the totality of the model (it can store only some chunks).
Dynamic reevaluation (440)
   Dynamic DL bitrate reevaluation (441);
   Dynamic inference reevaluation (442); or
   Dynamic DL bitrate and inference reevaluation (443).

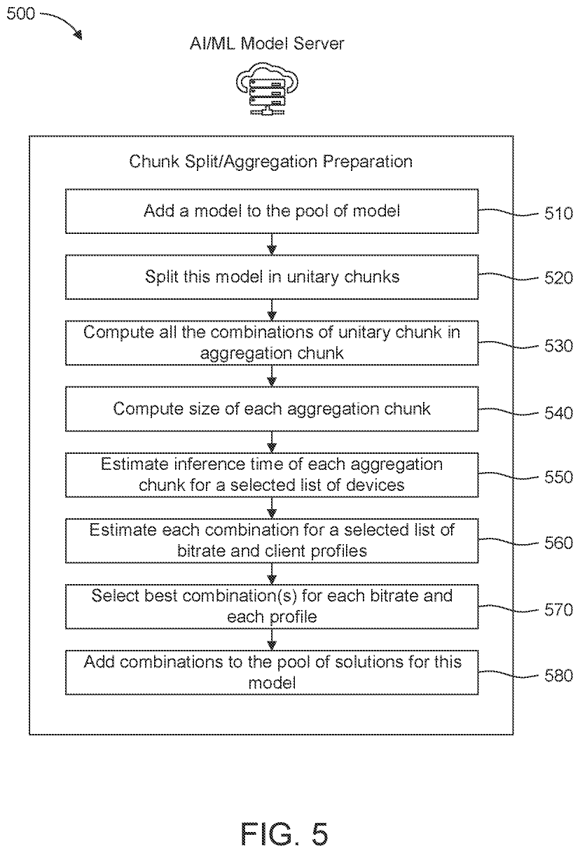

FIG. 5 illustrates a workflow of the chunk split/aggregation preparation operation, according to an embodiment. This can be used in block 410 of FIG. 4 for chunk split/aggregation preparation at the server side.

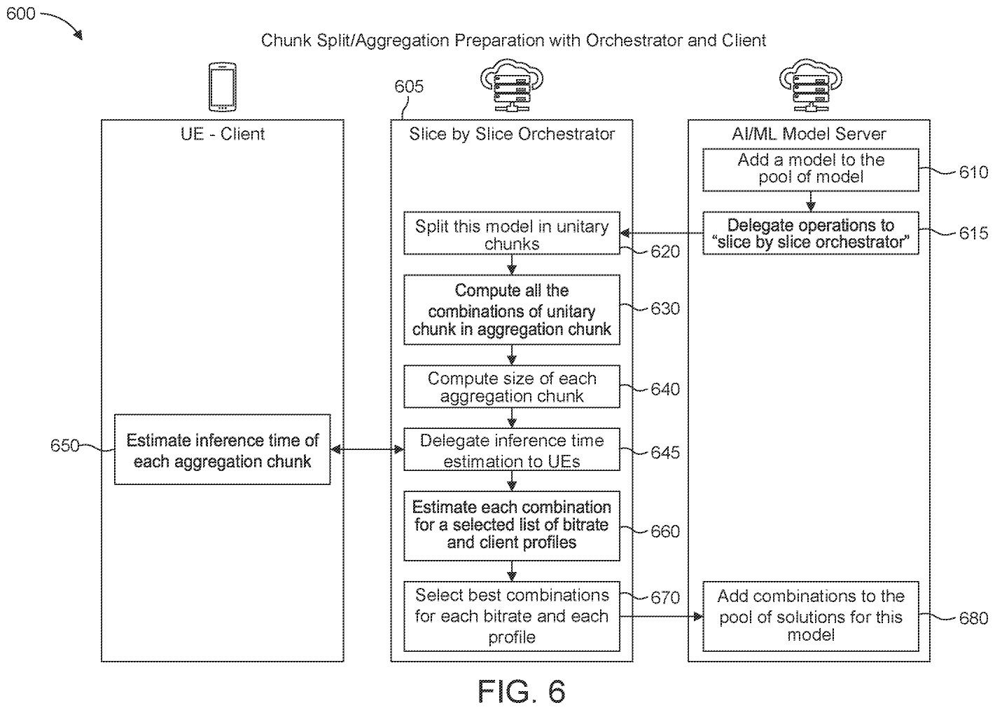

FIG. 6 illustrates another workflow (600) of the chunk split/aggregation preparation operation with an orchestrator (or controller, 605) and client, according to another embodiment. A controller can run in the cloud, the edge or RAN. In block 610, the AI/ML model server adds a new model to the pool of available models for download. In blocks 620-640, the orchestrator (that can be deployed on a remote server) computes the different combinations of aggregation chunks corresponding to different model splits. In block 645-650, the inference times of aggregation chunks is remotely estimated on selected UEs. In block 660-670, the controller estimates and select the best combinations of chunks associated with bitrates and profiles. The result is added to model server in block 680.

More particularly, the slice by slice orchestrator (105) hosts functions of blocks 620, 630, 640, 660, 670 and delegates function of block 650. In the AI/ML model server, the first step is to provision the server with a candidate ML model, i.e., adding a model to the pool of model (610). In step 615, the AI/ML server delegate operations to the “slice by slice orchestrator” (605), i.e., makes a request to the slice by slice orchestrator to run the function of blocks 620, 630, 640, 650, 660 and 670.

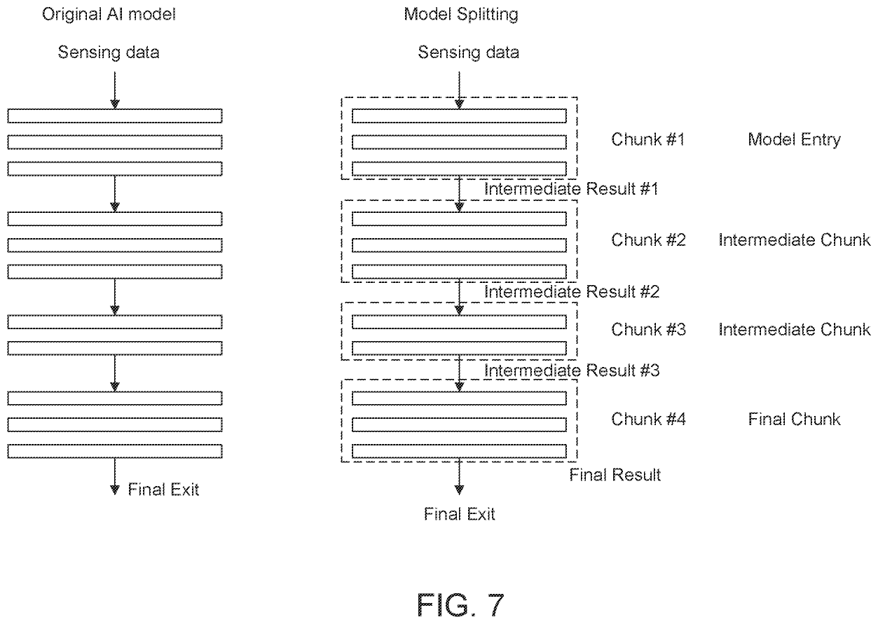

In block 120, the orchestrator splits the model in unitary chunks. For example, the AI/ML model is partitioned in several unitary chunks, as shown in FIG. 7. Split is made at neural network layer levels/group of layers. Each unitary chunk must be able to generate intermediate results. Those unitary chunks are saved in a pool of unitary chunks associated to the model, and will be used by the next block (630). The more convenient way is to split the model at layers having a smaller number of inputs and a smaller number of outputs (e.g., smaller input/tensor size, one input path and one output path).

In one embodiment, the base station raises a signalling bit to inform UE that a chunk is available. When UE wakes up (for a limited period of time), the gNB sends a chunk. The UE can make inference on the chunk, save intermediate data and go back to idle mode. This can be used in a 3GPP system that supports reduced compatibility UE in idle mode.

Model partitioning can be:
Static (chunks are offline prepared and provisioned on the AI/ML model server); or
Dynamic: chunks, and number of chunks, are dynamically defined by taking into account device memory available, device DL bandwidth.

Model split is made at neural network layer, and each chunk contains one to n layers. The first split corresponds to a first chunk of AI/ML layers that, once downloaded, is useable as is, and generates intermediate results on the basis of some input data. This first chunk uses the same input data as the full AI model. The next chunks use the intermediate results from the inference made on the previous chunk. That is, chunks are chained: chunk #(n+1) uses intermediate result of chunk #n. The inference from the chunks (except from the final chunk) is called intermediate result. The final chunk gives the final output result useable by the application/user, for instance the class of the object for the object detection model. This final output result is the same as the one provided by the original ML model (with the same accuracy performance).

The list of chunks will be communicated to the device (shown in Block 430 “Slice by slice AI model inference service” in FIG. 4). Chunks are identified with ID.

Each aggregation chunk contains one or more of the following:
A chunk ID.
The chunk ID of the preceding chunk it is tied to.
Its type: model entry, intermediate chunk, or final chunk.
The total number of chunks for that model and the chunk index, e.g., total_number=7 chunk_index=2.
Its size.
An expected inference time of each chunk on one or several target devices.
The reference bitrate that has been used as a basis for the split.
The device profile that has been used as a basis for the split.

Chunks may be optimized in size (i.e., lossless compressed) for the transport.

Once the model is split into unitary chunks, we can envisage to combine unitary chunks to make larger aggregation chunks (130) to reach a better balance between aggregation chunk size and latency (download time and inference time). The objective is to define the optimal size of each aggregation chunk to optimize the parallelization.

We can build a list of aggregation chunks resulting of a combination from 1 to n unitary chunks. In one embodiment, the mandatory condition is to respect the same order as the existing order in the full reference model and to use all the unitary chunks.

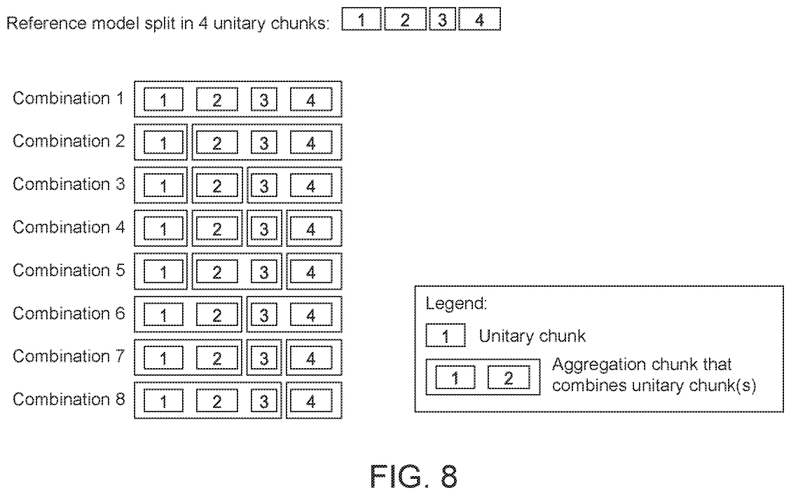

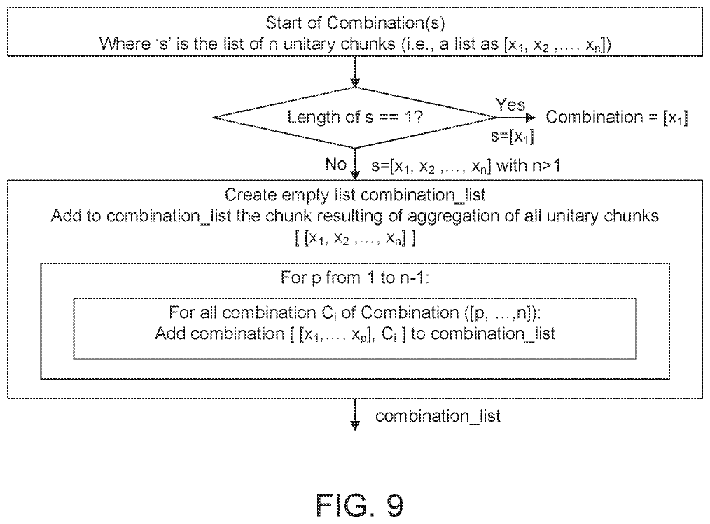

For a model with four unitary chunks, all possibilities are shown in FIG. 8. FIG. 9 it lustrates the generic algorithm that builds the list of all combinations. In the following, the algorithm is described in a high-level description language (pseudo-code).

```
Where ‘s’ is the list of n unitary chunk (i.e., a list as [x₁, x₂, ... , xₙ] )
Function Combination (s):
          n = length of s
          if n == 1:
            combination_list = [s]
          else:
            combination_list = [ ]
            # add aggregation of all unitary chunks
            Add [s] to combination_list
            For p from 1 to n-1:
            For all combination Cᵢ of Combination([p, ...,n]):
                  Add to combination_list [ [x₁,..., xₚ], Cᵢ]
          return combination_list
```

For each chunk of each combination, we measure or estimate (640) the chunk size, we compute the time to download the chunk at the predefined bitrate, and measure or estimate the inference time.

We first obtain the memory size required to store each unitary chunk. For each unitary chunk, we build a sub-model composed of this unitary chunk, save the sub-model and get the file size. We then obtain the size of (aggregation) chunk. The estimation of the chunk size can be done with following methods:
Measurement: Build explicitly the model by aggregation of unitary chunks that compose the chunk, save the model and get the file size.
Estimation: Estimate that the size of the aggregation chunk is close to the sum of the size of each unitary that compose the chunk:

$${chunk}_{i} = [ unitary {chunk}_{m} , unitary {chunk}_{m + 1} , … , unitary {chunk}_{p} ] \\ size ( {chunk}_{i} ) = {\sum }_{k = m}^{p} size ( unitary {chunk}_{k} )$$

In block 645, the orchestrator delegates block 650 to UE devices to get inference time.

In block 650, chunk inference time is estimated. We can first obtain the inference time of each unitary chunk. The inference time depends on the target device. We can envisage several possibilities to estimate chunk inference time, according to the trade-off we are ready to accept between time needed to get the results and accuracy:
Measurement: For each unitary chunk, we build the sub-model composed of this unitary chunk and:
   run the inference, and measure the inference time it takes on a reference server.
   run the inference, and measure the inference time it takes on a target device.
   run the inference, and measure the inference time it takes on a reference target device.
Estimation: Estimate the inference time it will take on a target device by applying a correction factor α on the inference time measured on a reference server

inference time(unitary chunkᵢ)_{targetdevice}=α·inference time(unitary chunkᵢ)_{referenceserver}
The correction factor α can be estimate by measuring the inference on a same reference model both on the reference server and the target device.

$$∝ = \frac{inference {time ( reference model )}_{targetdevice}}{inference {time ( reference model )}_{referenceserver}}$$

Estimation: Estimate the inference time it will take on a target device by applying a correction factor α on the inference time measured on a reference target device.

inference time(unitary chunkᵢ)_{targetdevice}=α·inference time(unitary chunkᵢ)_{referencetarget}
The correction factor α can be estimate by measuring the inference on a same reference model both on the reference target and the target device.

$$∝ = \frac{inference {time ( reference model )}_{targetdevice}}{inference {time ( reference model )}_{referencetarget}}$$

Estimation: Estimate the inference time it will take by using indication on the type of neurons present on the layers. Type of neurons can be, but not limited to: neuron with activation functions (perceptron), convolutional (CNN), recurrent neural network (RNN), Long Short Term memory (LSTM). Once we have some results on layers of different type we may evaluate the inference of other layers of the same type.
Estimation: In order to be able to compare the results of the proposed methods with the baseline (the reference time with the classic sequential method download followed by inference), and supposing a perfect implementation, the following method can be used. We use this method in the experimentation described later.
1. Measurement: For each unitary chunk, we build explicitly the model and run the inference, and measure the inference time it takes either on a reference server or on a target device.
2. Compute the proportion each unitary chunk represents comparing to the total time of inference.
3. Apply this proportion to the total time of inference obtained with the baseline to determine a theoretical value for each unitary chunk.

The estimation of the aggregation chunk inference time can be done with following methods:
Measurement: Build explicitly the model by aggregation of unitary chunks that compose the chunk, then:
   run the inference, and measure the inference time it takes on a reference server.
   run the inference, and measure the inference time it takes on a target device.
   run the inference, and measure the inference time it takes on a reference target device.
Estimation: Estimate that the inference time of the aggregation chunk is approximately the sum of the inference time of each unitary that compose the chunk:

$${chunk}_{i} = [ unitary {chunk}_{m} , unitary {chunk}_{m + 1} , … , unitary {chunk}_{p} ] \\ size ( {chunk}_{i} ) = {\sum }_{k = m}^{p} size ( unitary {chunk}_{k} )$$

The inference time of each unitary chunk may be obtained via the various method described above.
Estimation: As described above, estimate the inference time it will take on a target device by applying a correction factor α on the inference time measured on a reference server.

inference time(chunkᵢ)_{targetdevice}=α·inference time(chunkᵢ)_{referenceserver}
The correction factor α can be estimated by measuring the inference on a same reference model both on the reference server and the target device.

$$∝ = \frac{inference {time ( reference model )}_{targetdevice}}{inference {time ( reference model )}_{referenceserver}}$$

Estimation: As described above, estimate the inference time it will take on a target device by applying a correction factor α on the inference time measured on a reference target device.
inference time(chunkᵢ)_{targetdevice}=α·inference time(chunkᵢ)_{referencetarget}
The correction factor α can be estimated by measuring the inference on a same reference model both on the reference target and the target device.

$$∝ = \frac{inference {time ( reference model )}_{targetdevice}}{inference {time ( reference model )}_{referencetarget}}$$

Estimation: Estimate that the inference time of the aggregation chunk is approximately the sum of the inference time of each unitary chunk that compose the chunk:

$${chunk}_{i} = [ unitary {chunk}_{m} , unitary {chunk}_{m + 1} , … , unitary {chunk}_{p} ] \\ size ( {chunk}_{i} ) = {\sum }_{k = m}^{p} size ( unitary {chunk}_{k} )$$

The inference time of each unitary chunk may be obtained via the various methods described before.

Then in block 660, we may compute the total time to make the full inference. For example, for each combination we may run the below algorithm to compute the total time it will take to download and make the inference of all chunks.
T₀=Start of Experimentation
UE_{DL}=UE DownLink Bitrate in bit/s
S_{c}_{ᵢ}=Size of chunk i in bytes
DD_{c}_{ᵢ}=Download duration of chunk i

$$1 \leq i \leq n , {DD}_{{C}_{i}} = \frac{8 * {S}_{{C}_{i}}}{{UE}_{DL}}$$

TA_{c}_{ᵢ}=Time where chunk i is downloaded and available for inference

TA_{c}_{₁}=T₀+DD_{c}_{₁}

1<i<n−1, TA_{c}_{ᵢ₊₁}=TA_{c}_{ᵢ}+DD_{c}_{ᵢ₊₁}
ID_{c}_{ᵢ}=Inference duration of chunk i
TR_{c}_{ᵢ}=Result time of chunk i inference
   There are two possibilities to define TR_{c}_{ᵢ} either by referencing TA_{c}_{ᵢ} or by referencing W_{c}_{ᵢ}
      Possibility 1:

TR_{c}_{₁}=TA_{c}_{₁}+ID_{c}_{₁}

1<i≤n−1, TR_{c}_{ᵢ}=Max(TR_{c}_{_{i−1}},TA_{c}_{ᵢ})+ID_{c}_{ᵢ}
Possibility 2:

TR_{c}_{₁}=T₀+W_{c}_{₁}+ID_{c}_{₁}

1<i≤n−1, TR_{c}_{ᵢ}=TR_{c}_{_{i−1}}+W_{c}_{ᵢ}+ID_{c}_{ᵢ}
W_{c}_{ᵢ}=Wait time duration to start chunk i inference

W_{c}_{₁}=TA_{c}_{₁}−T₀

1<i≤n, W_{c}_{ᵢ}=Max(0,TA_{c}_{ᵢ}−TR_{c}_{_{i−1}})

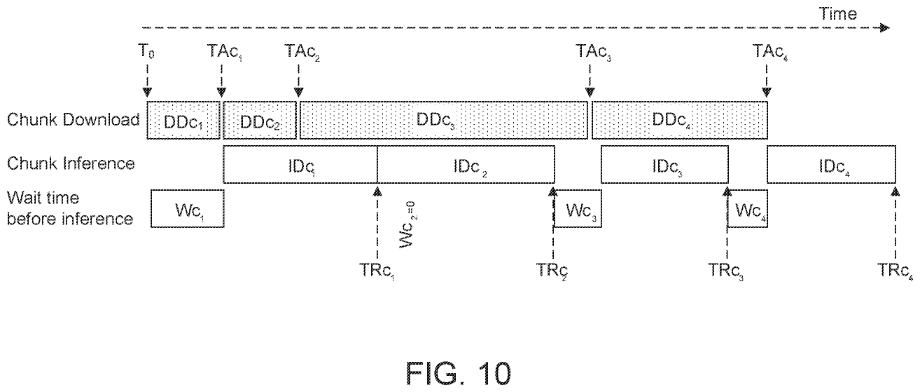

FIG. 10 illustrates an example of chronological representation—parallelization of chunk download and inference. In this example, after the inference of the first chunk is completed (TR_{c}_{₁}), the download of the second chunk has already completed (TA_{c}_{₂}). Thus, the inference of the second chunk can start immediately and the wait time is 0 (W_{c}_{₂}=0). However, after the inference of the second chunk is completed (TR_{c}_{₂}), the download of the third chunk is still ongoing (until TA_{c}_{₂}). Thus, the inference of the third chunk cannot start immediately and the wait time is W_{c}_{₃}.

In block 670, the best result is obtained when the result time of the last chunk TR_{c}_{ₙ} is the smallest as possible. This is the case when:
The total wait time (Σᵢ₌₁ⁿW_{c}_{ᵢ})+Inference time of the last chunk ID_{c}_{ₙ} is minimized, or
When the download time of chunks are close to the inference time, and when the download time of the first chunk and inference of the last chunk are smallest as possible, i.e., when Σᵢ₌₂ⁿDD_{c}_{ᵢ}=Σᵢ₌₁ⁿ⁻¹ID_{c}_{ᵢ}, and DD_{c}_{₁} and ID_{c}_{ₙ} smallest as possible.

In this case the parallelization is maximum between the download and the inference. DD_{c}_{ᵢ} and ID_{c}_{ᵢ} are dependent on the unitary chunk aggregation. The goal of the optimal aggregation is to aggregate unitary chunks so that DD_{c}_{ᵢ₊₁} and ID_{c}_{ᵢ} are close, i.e., when the inference of chunk [i] is close or equal to the download of the next chunk [i+1]. In case several solutions give the same total wait time (with a range of variation), it can be decided to retain the solution having the least number of chunks to minimize the complexity of the solution.

For each bitrate, and each user profile, the best solution, split in chunks, is then added (680) to the pool of solutions for this model.

Exchange Between Server Side and Client Side (420)

To facilitate the exchange between server and client, it can be envisaged a predefinition of a list of device profiles. For instance, low-end smartphone, mid-range smartphone, high-end smartphone, or a more accurate specific list of profiles based on a calibration phase.

The objective of the calibration phase (420) between the client and the server is to have a good knowledge of the client characteristics regarding its DL bitrate and its inference capabilities.

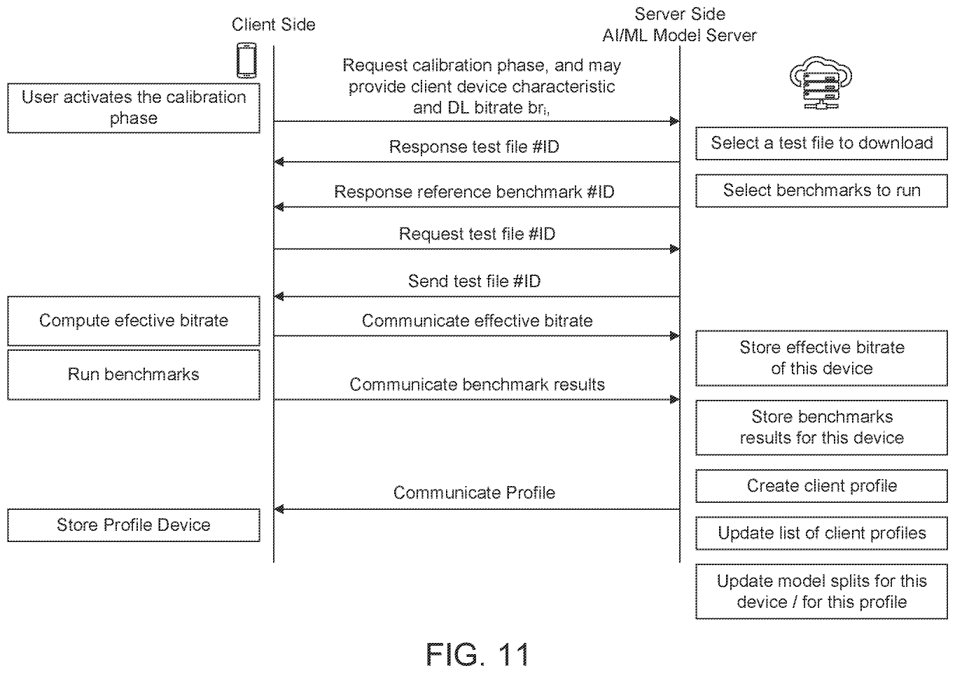

This calibration phase may be performed when the user installs or starts the service the first time, for example, as shown in FIG. 11. The calibration phase may run these operations:
Run an explicit file download with the AI/ML server to get a good knowledge of the effective DL bitrate between the client and the server. This operation may be redone at any moment by the client to consider DL bitrate variation due to the time of the day or geographic position.
Run a benchmark of reference models (as AI Benchmark, MLPerf for instance) to get a good knowledge of the machine learning capabilities of the device. This result may be saved in a “profile”.

Slice by Slice AI Model Inference Service (430)

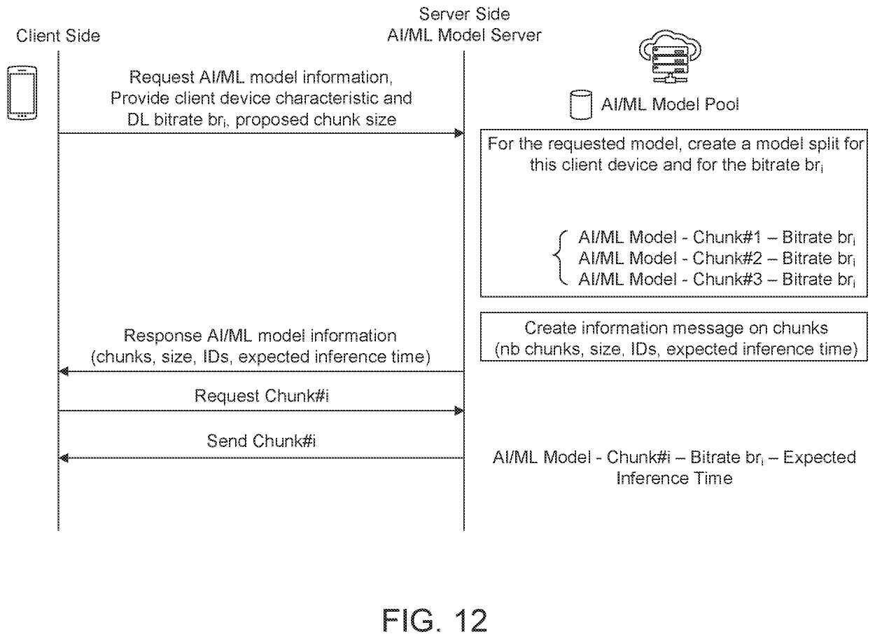

FIG. 12 illustrates slice by slice AI model inference service call flow when the model split is under AI/ML model server control (when the preparation of block 410 has been made for this model), according to an embodiment.

The client sends a request for a machine learning model to the server and can provide its device characteristics (CPU model, GPU/NPU/DSP, RAM size, AI Benchmark score, product reference) or its profile obtained from the calibration phase and its downlink (DL) bitrate.

In a variant, the client can also propose a chunk size for the first (aggregation) chunk. It is noted that we assume the client has a knowledge of its initial DL bitrate, based for instance on its last download experience. It can also be a result of the calibration phase.

If the chunk split/aggregation preparation of block 410 has been made, the server selects the best combination of (aggregation) chunks of this model considering the client device characteristics/profile and DL bitrate. Otherwise, the server creates a model split based on unitary chunks. The server sends information regarding model split (number of chunks, size and ID of each chunk, expected inference time of each chunk on the target device, or reference inference time).

The client sends a download request for each chunk. This request can include a proposed chunk size (or a range of chunk size), a proposed inference time (or a range of inference time) and include inference time of the previous chunk (as described in Block 440 Dynamic reevaluation). It can also include a proposed “aggregation chunk” that combine some unitary chunks.

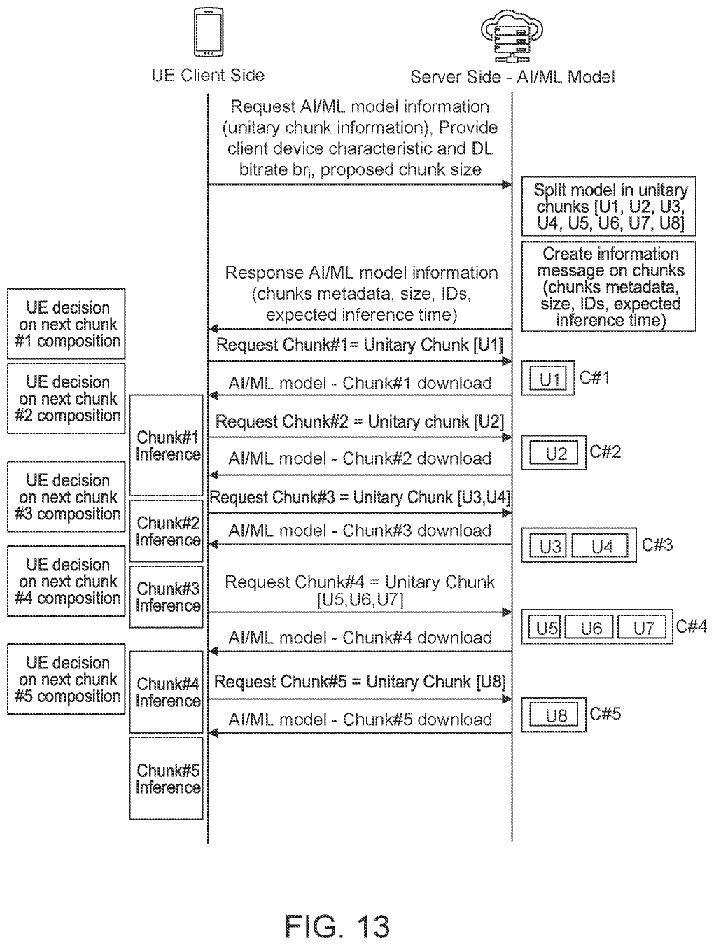

FIG. 13 illustrates slice by slice AI model inference service call flow when the model split is under UE control, according to an embodiment.

At the client side, we consider different use scenarios. In one scenario, the latency (model download+first inference) is critical for the end user experience, and the client can have enough memory to store the full model (i.e. enough memory to store all the chunks).

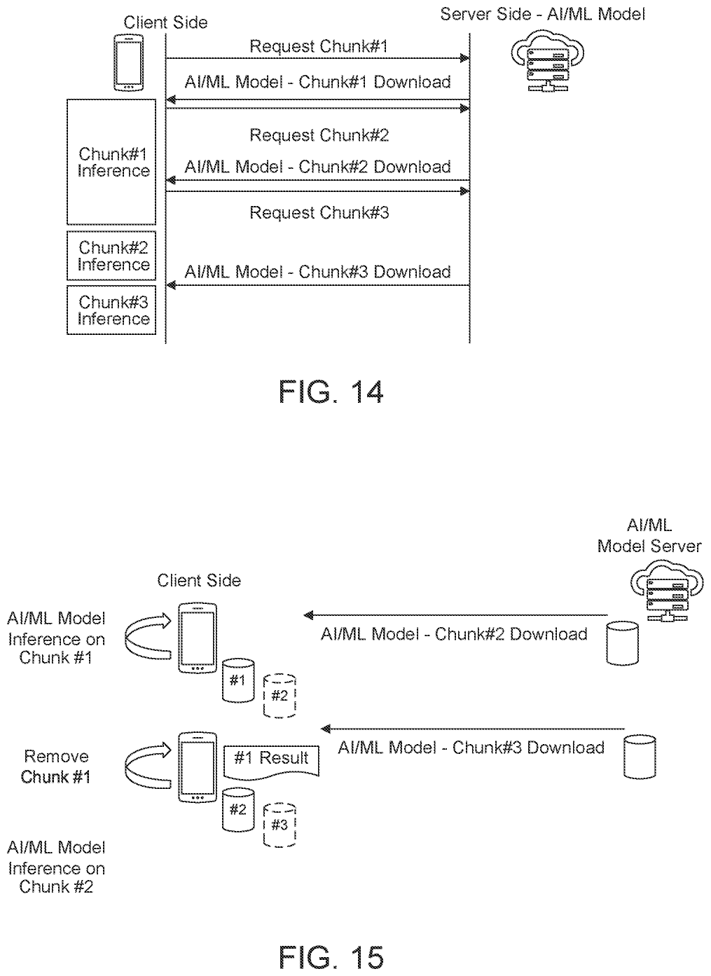

As shown in FIG. 14, the client sends sequentially a download request for each chunk, and makes the inference of each chunk as soon as the chunk is downloaded as described in FIG. 10. When the last chunk is downloaded, and the inference made once on this last chunk, the client side can rebuild the full model from all the chunks, to make the next inferences.

In another use scenario, the client has NOT enough memory to store the totality of the model (it can store only some chunks).

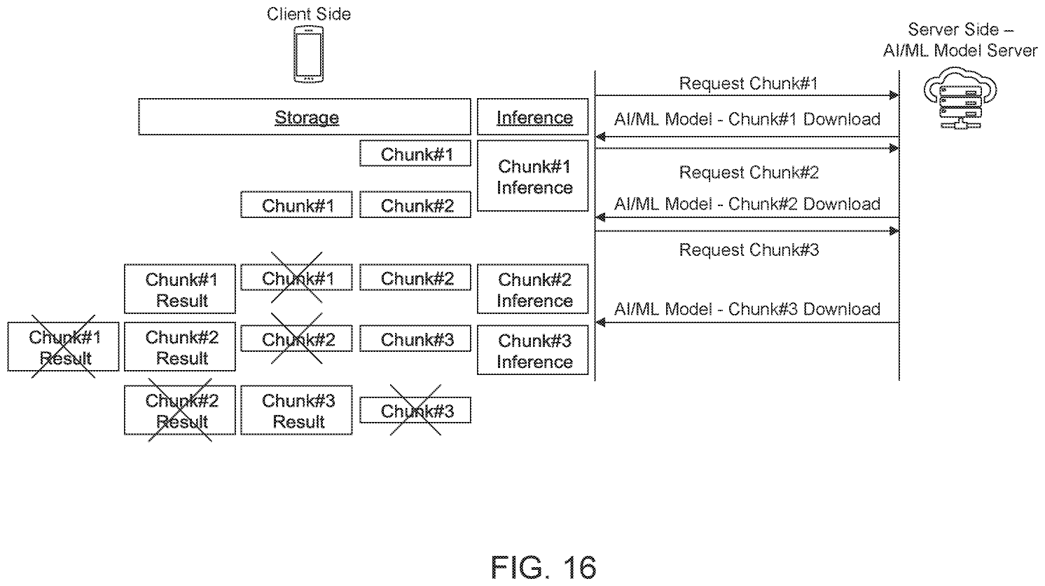

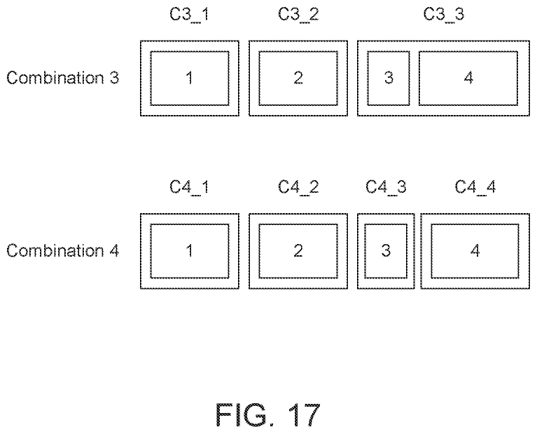

As shown in FIG. 15, the client sends a download request for each chunk, and makes the inference of each chunk as soon as the chunk is downloaded as described in FIG. 10. When the inference is made on a chunk, the client side can delete the chunk, as shown in FIG. 16.

When the last chunk is downloaded, and the inference made once on this last chunk, the client side may restart the process with a first chunk request to make the next inference.

Dynamic Reevaluation (440)

After reception of each chunk, we can reevaluate (441) the average real bitrate on the client side and asks the server to take a potential new split decision that may consider this new bitrate.

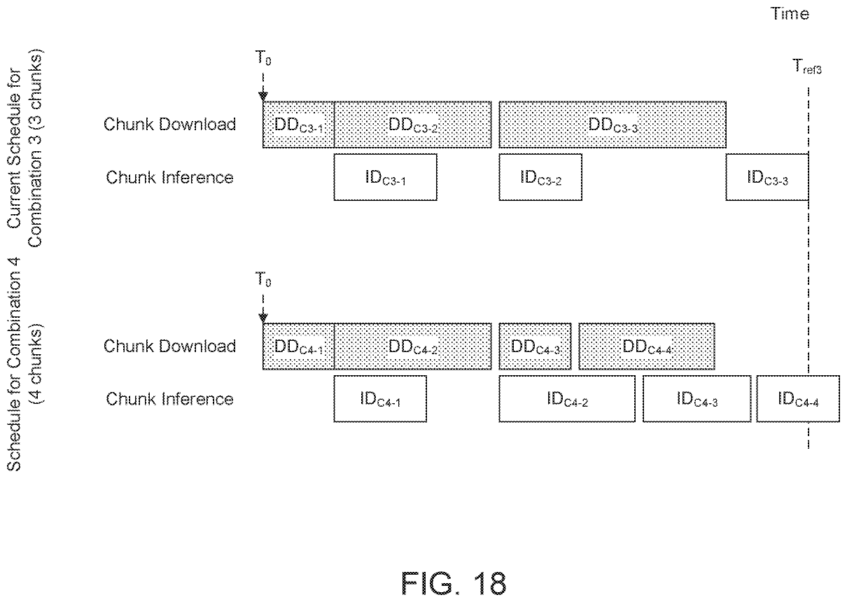

As an illustration, in the previous sample with for unitary chunks, if the ongoing combination is combination 3, and we are currently downloading the first chunk, the server may decide to switch to combination 4 if the new estimated time is better with combination 4 than combination 3 due to the change of bitrate, as shown in FIG. 17. As a response, the server sends updated information (new combination, new list of chunks and their IDs).

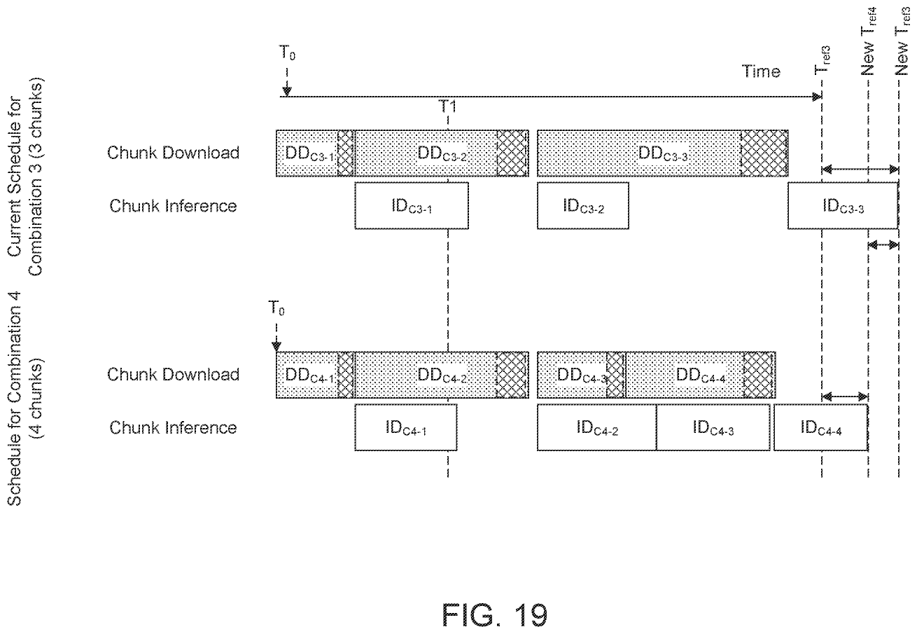

For the next scheme, as shown in FIG. 18, we will refer as C3_1, C3_2 and C3_3 the first, second and third chunk, respectively, of combination 3. We will refer as C4_1, C4_2, C4_3 and C4_4 the first, second, third and fourth chunk, respectively, of combination 4.

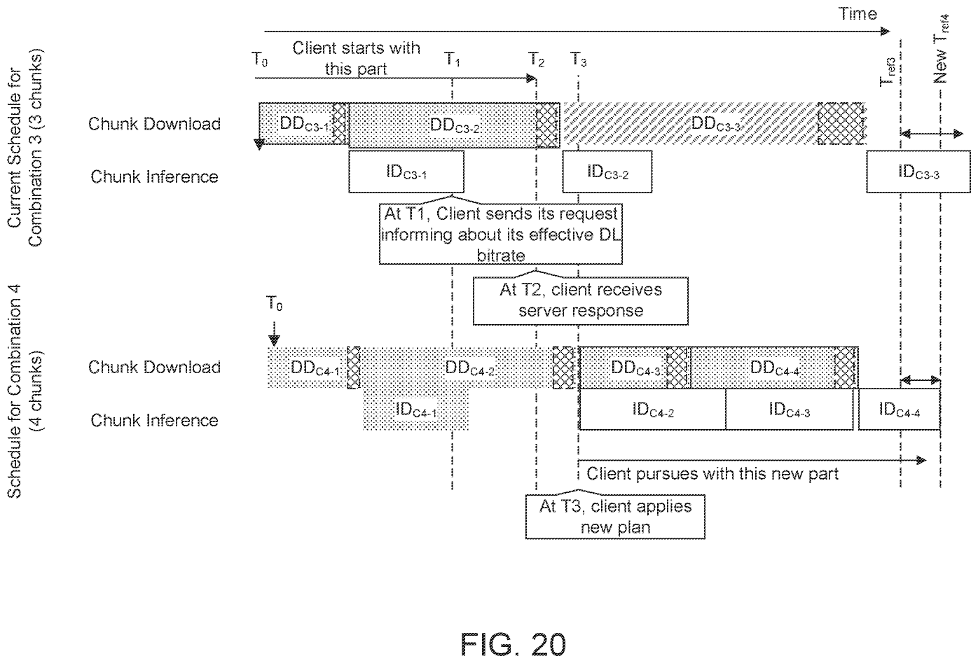

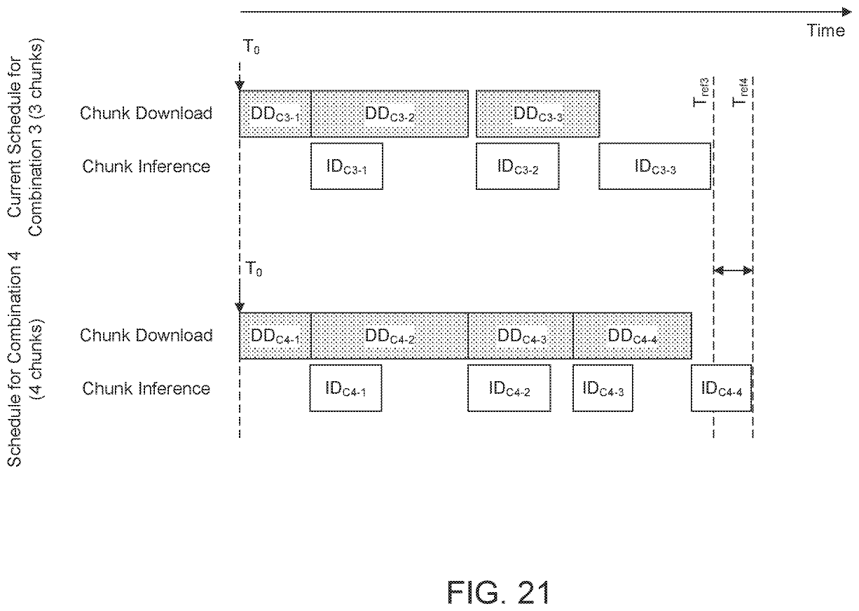

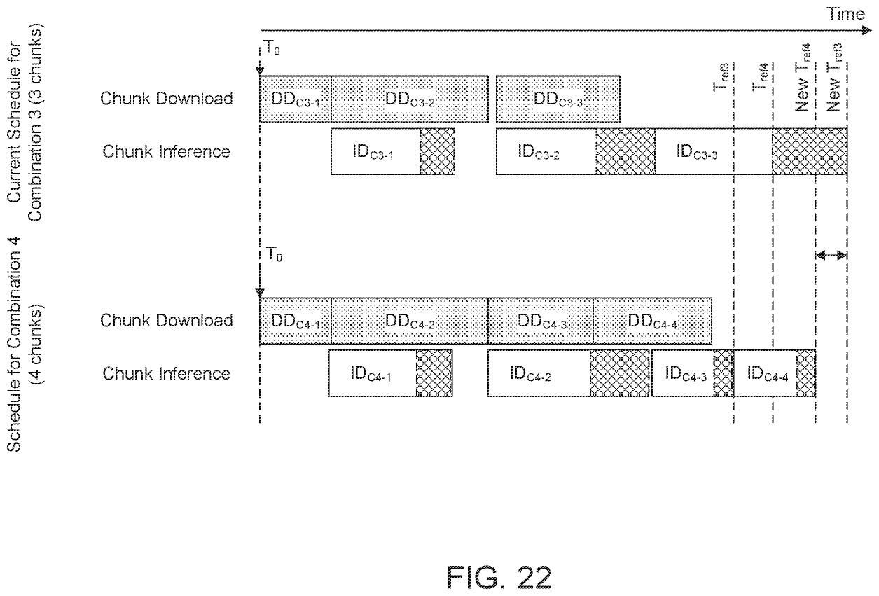

FIG. 19 illustrates an initial Schedule of combination 3 and 4 with the expected initial bitrate. FIG. 20 illustrates the updated Schedule of combination 3 and 4 with the revised effective bitrate. With the new revised effective bitrate, combination 4 is now better than initial combination 3. FIG. 21 illustrates the schedule switch between combination 3 and combination 4 due to dynamic bitrate reevaluation.

The server can send the following information:
New list of chunks that still need to be downloaded.
Expected inference time of each chunk.

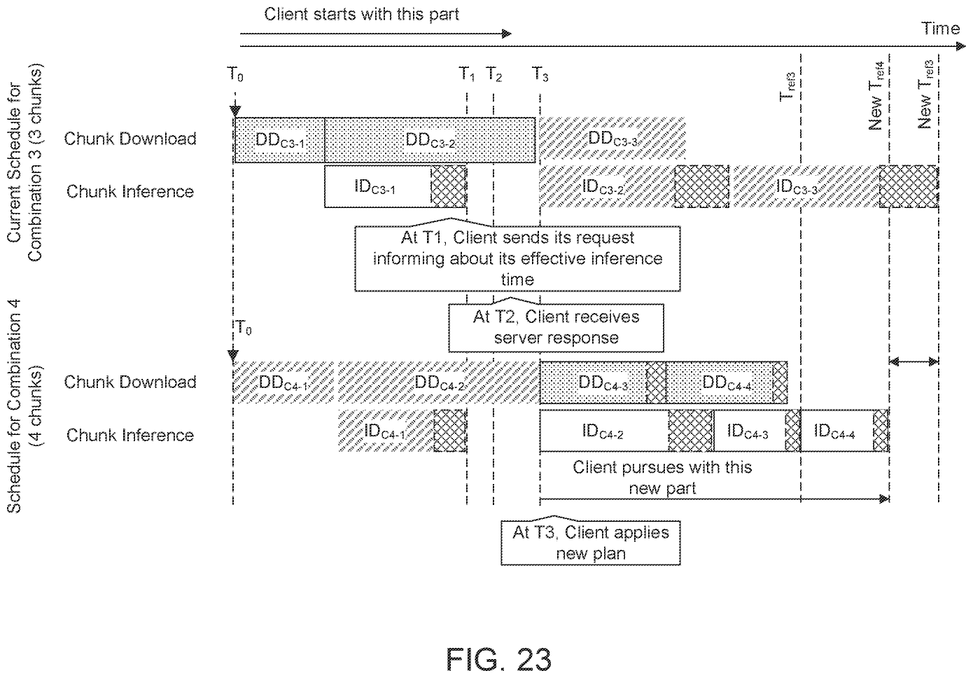

In a similar way, after inference of each chunk, the client can compare/update (442) its real inference time with the expected inference time provided by the server. In case of difference the client can ask the server to take a potential new split decision that may consider this new inference time. For example, as illustrated in FIG. 22, we assume the inference has been made on chunk 1 and the downloading of chunk 2 is ongoing, and the client has now a better knowledge of its effective inference time. The client sends a request to the server to re-estimate the best combination. As a response the server sends updated information (new combination, new list of chunks and their IDs).

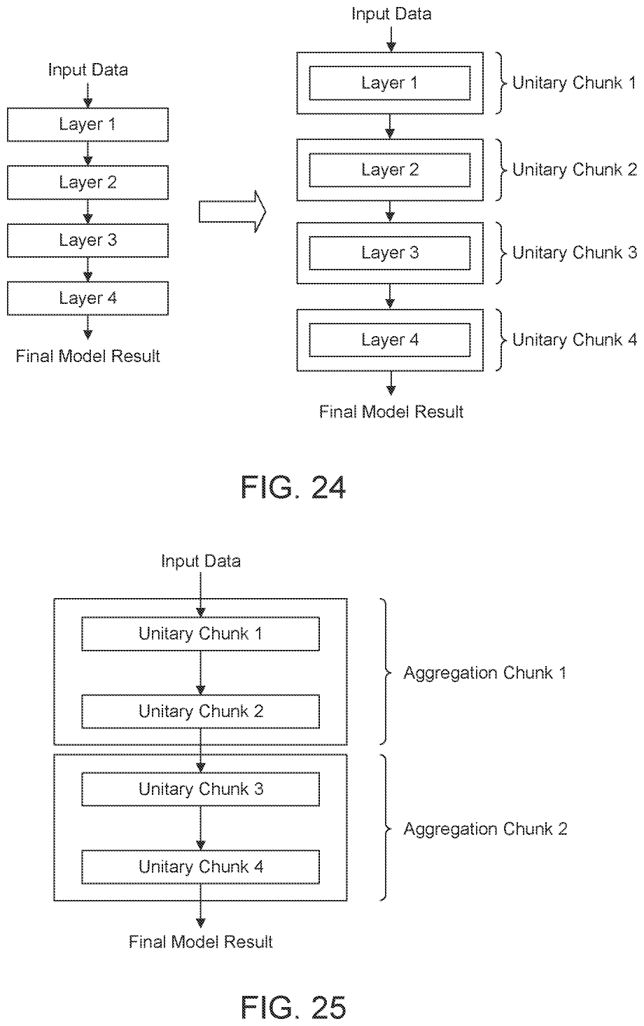

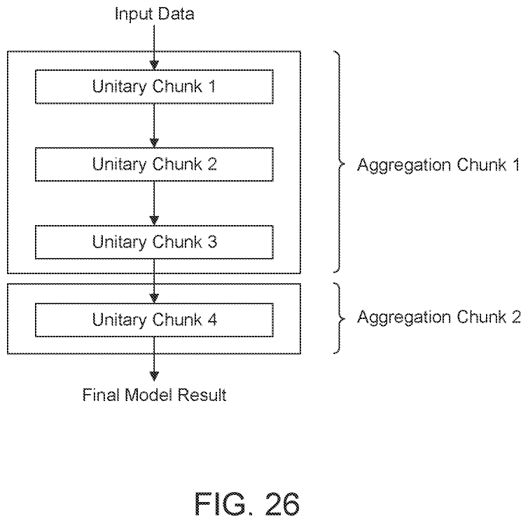

FIG. 23 illustrates an initial Schedule of combinations 3 and 4 with the expected initial inference. FIG. 24 illustrates an updated Schedule of combinations 3 and 4 with the revised effective inference.

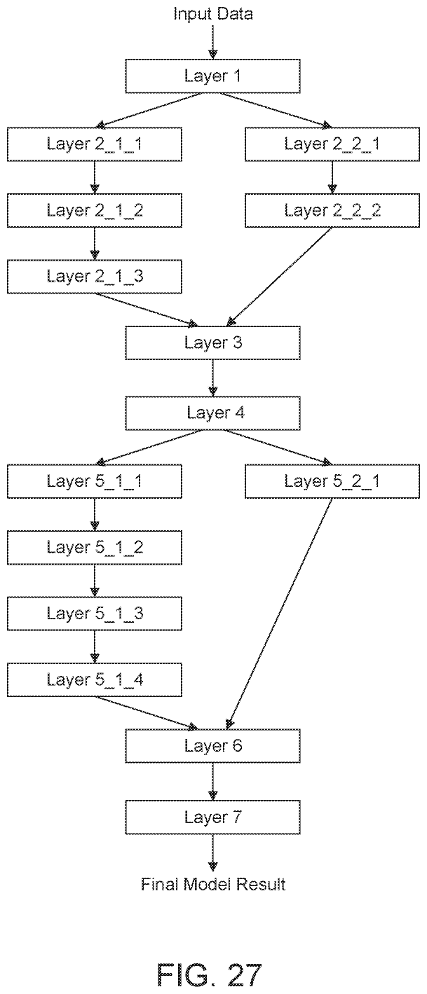

With the new revised effective inference, combination 3 is more impacted than the combination 4. Combination 4 is now better than the initial combination. FIG. 25 illustrates the schedule switching between combinations 3 and 4 due to dynamic inference reevaluation.

The server can send the following information:
New list of chunks that still need to be downloaded.
Expected inference time of each chunk.

As a combination of inference reevaluation and bitrate reevaluation, after reception of each chunk, the client can reevaluate (443) both the average real bitrate and inference of each chunk. It can then either ask the server to take a potential new split decision that may consider this new bitrate and new inference time, or request to the server a chunk of a size in a specific range or having an inference time in a specific range. It can also include a proposed “aggregation chunk” that combines some unitary chunks.

In the following, we provide some examples for chunk construction.

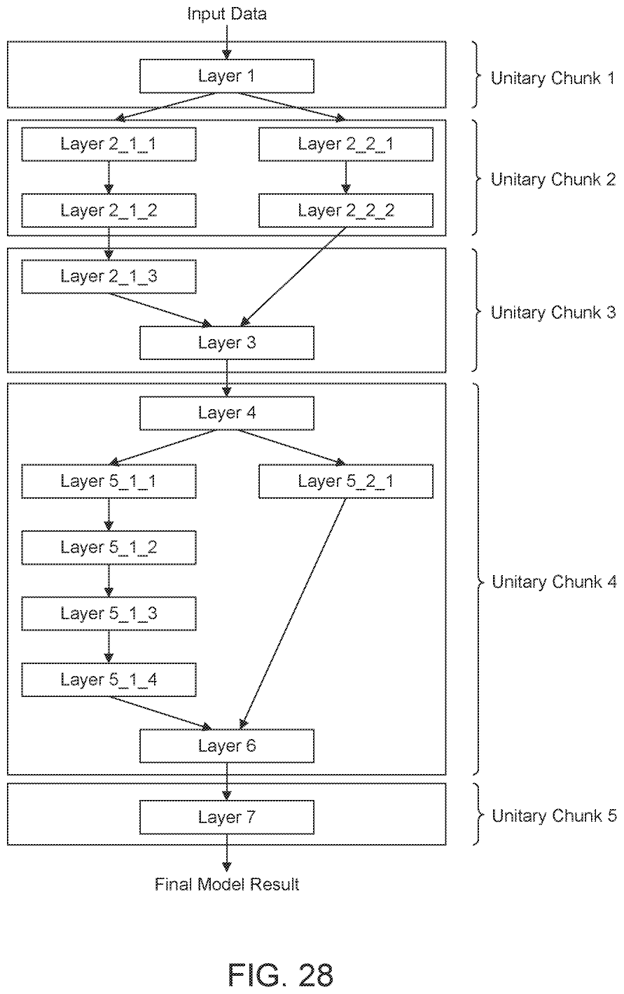

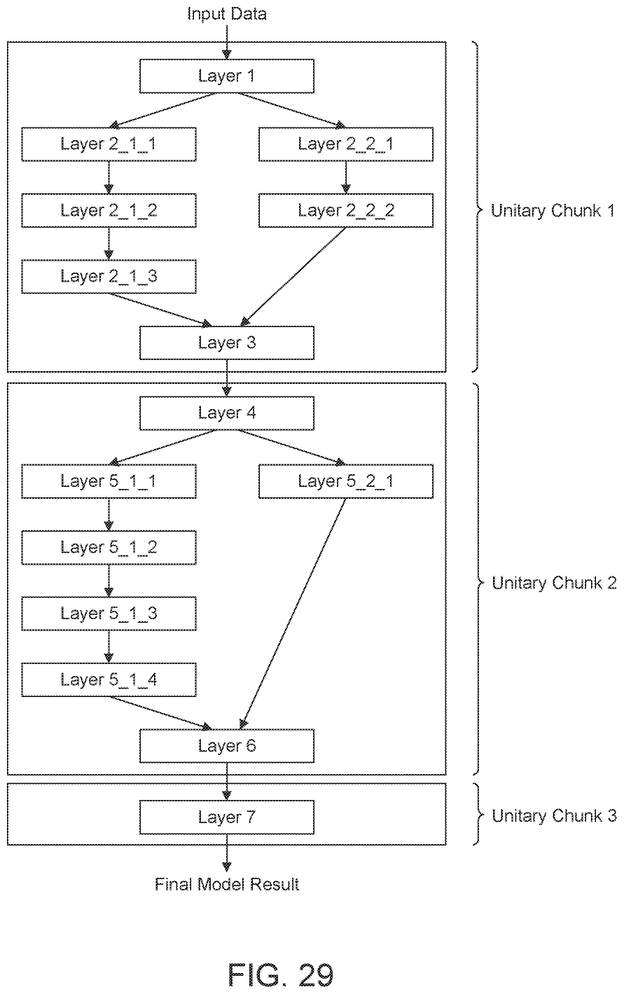

FIG. 26 shows an example where “unitary chunks” are mapped on “layer” for an AI/ML model with one input and one output. FIG. 27 and FIG. 28 show that “aggregation chunk” are the aggregation of one or more “unitary chunks”.

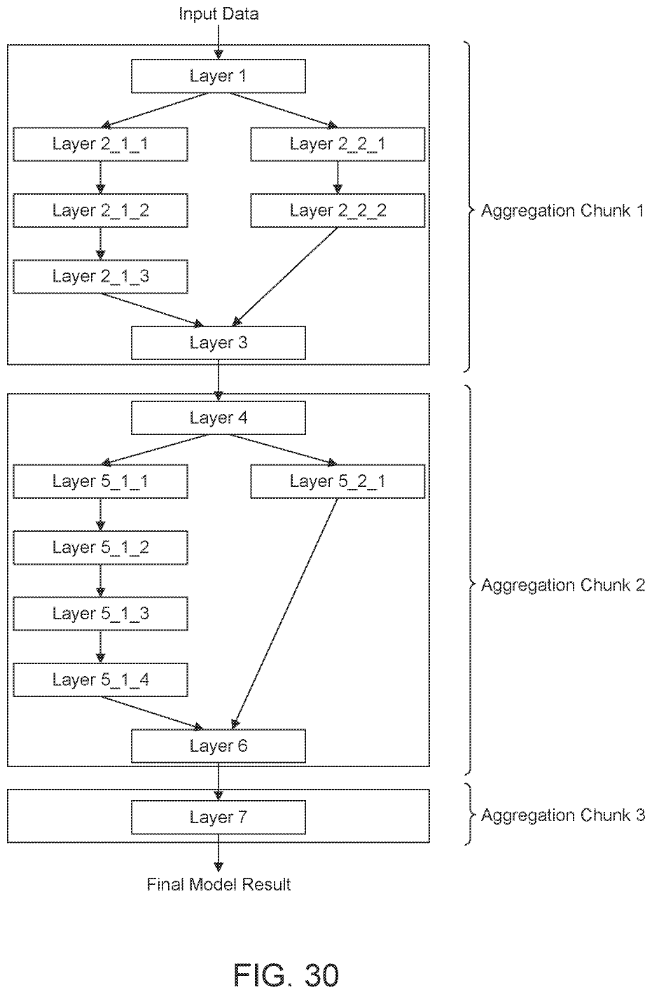

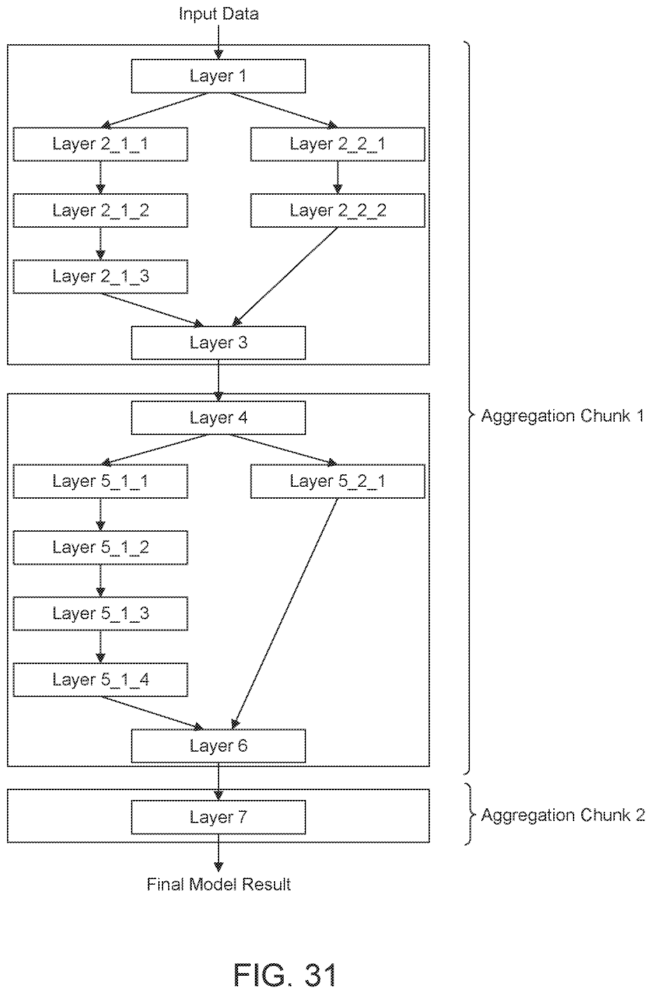

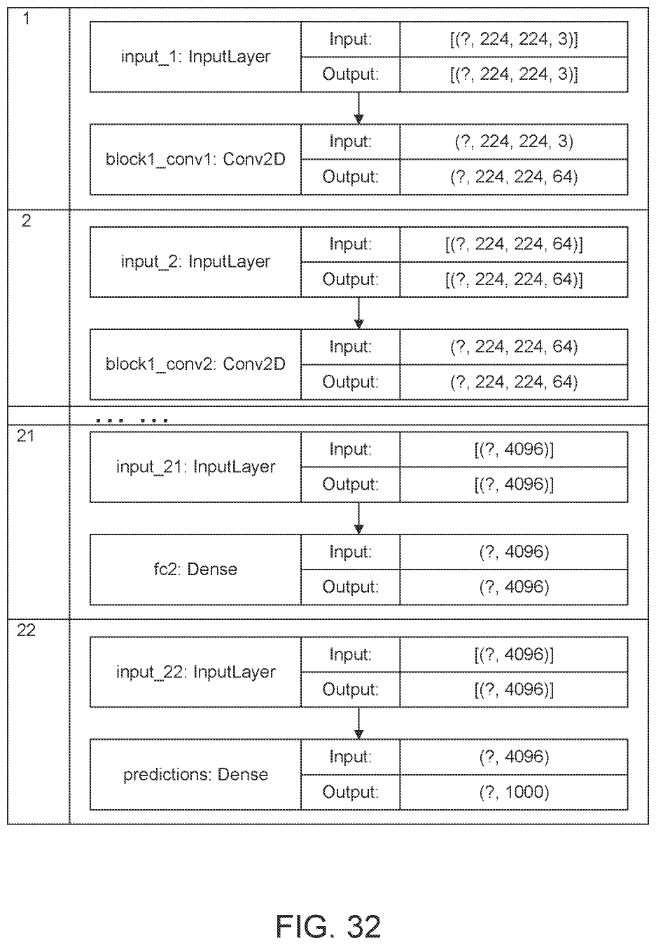

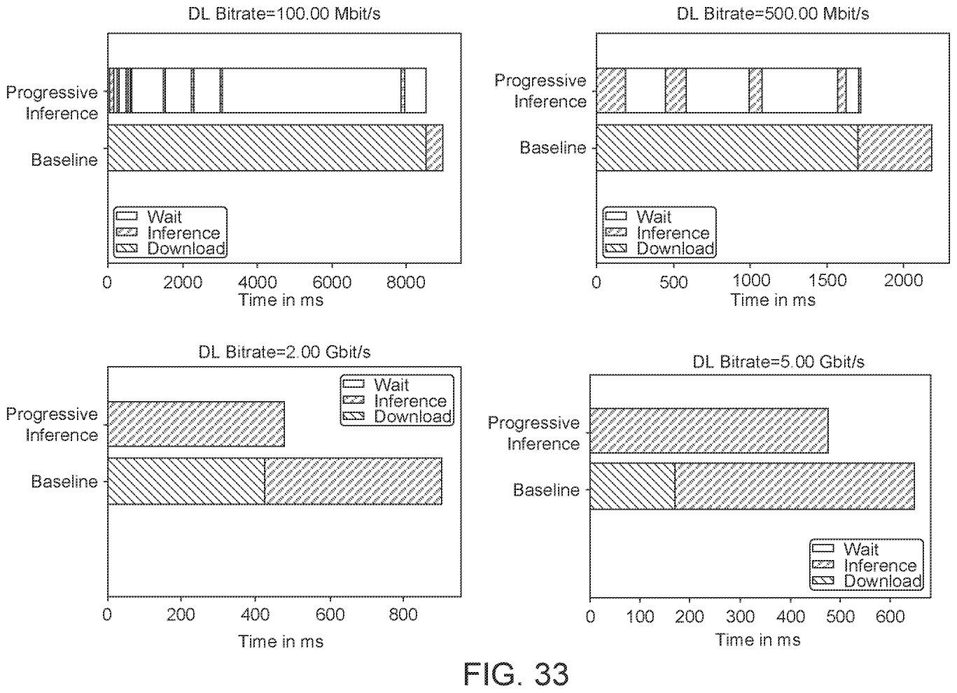

FIG. 29 shows an example model with hierarchical layers. FIG. 30 shows where unitary chunks are mapped on “layer” or group of layers. FIG. 31 shows another example of unitary chunks: layers are grouped in blocks having one input and one output. FIG. 32 and FIG. 33 show examples where aggregation chunk are the aggregation of one or more unitary chunks. The same figures exposed for simple layers are also applicable for hierarchical layers.

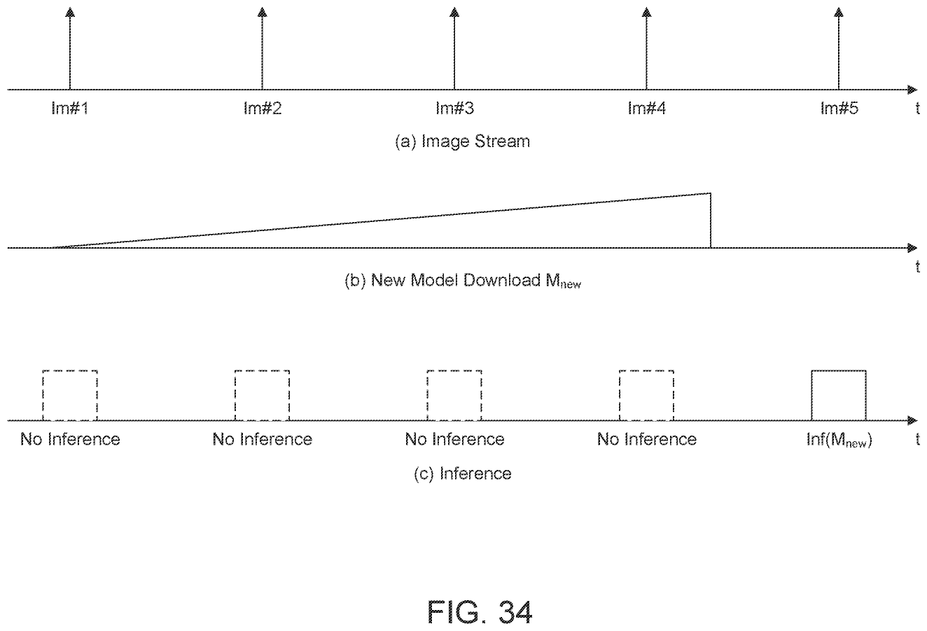

FIG. 34 illustrates that a VGG16 models composed of 22 stacked layers is 1 is split into 22 unitary chunks.

In another example, for Resnet-50 composed of stacked layers and hierarchical layers, each block can be mapped on a “unitary chunk”. Another possible mapping is to already group blocks in unitary chunks to form 18 “unitary chunks” for this model (i.e., x1 the first 6 block+x16 the middle blocks+x1 the last three blocks). Then, “unitary chunks” can be grouped to form “aggregation chunks” before transmission.

Using Resnet-50 as the AI model, and using Laptop/Ubuntu/TensorFlow as the test platform, we made an evaluation with the classical processes of download followed by inference to get reference values.

| Model | Size (bytes) | Inference time (ms) |
|---|---|---|
| resnet50 | 106437430 | 477 |

We then made an evaluation by splitting the Resnet model at each possible 18 potential split-points.

| Layer_indice | Layer_name | Layer_size | Layer_latency (measure) |
|---|---|---|---|
| 0 | split1 | 140711 | 45.211392 |
| 1 | split2 | 610045 | 68.116885 |
| 2 | split3 | 524416 | 56.364412 |
| 3 | split4 | 524416 | 56.668619 |
| 4 | split5 | 1835412 | 63.390856 |
| 5 | split6 | 1368230 | 57.283878 |
| 6 | split7 | 1368230 | 58.236592 |
| 7 | split8 | 1368230 | 55.443273 |
| 8 | split9 | 6383028 | 64.185471 |
| 9 | split10 | 4725953 | 55.408672 |
| 10 | split11 | 4725953 | 54.523763 |
| 11 | split12 | 4725953 | 55.612490 |
| 12 | split13 | 4725953 | 54.904168 |
| 13 | split14 | 4725953 | 57.203220 |
| 14 | split15 | 24522165 | 62.381841 |
| 15 | split16 | 18125999 | 54.490148 |
| 16 | split17 | 18125999 | 55.137243 |
| 17 | split18 | 8240054 | 32.923938 |

Thanks to this we compute proportion of latency of each chunk compare to the total latency and compute the minimum theoretical latency of each chunk based on the baseline latency.

We are then able to compute size and estimate potential latency of any combination of chunk without running the real experimentation. We generate all possible combination of chunks. There are 2\hat{ }17=131072 combinations. For each combination, and for a selection of bitrates, we compute the total time to finalize the inference with our proposed methods to compare the difference with the reference baseline.

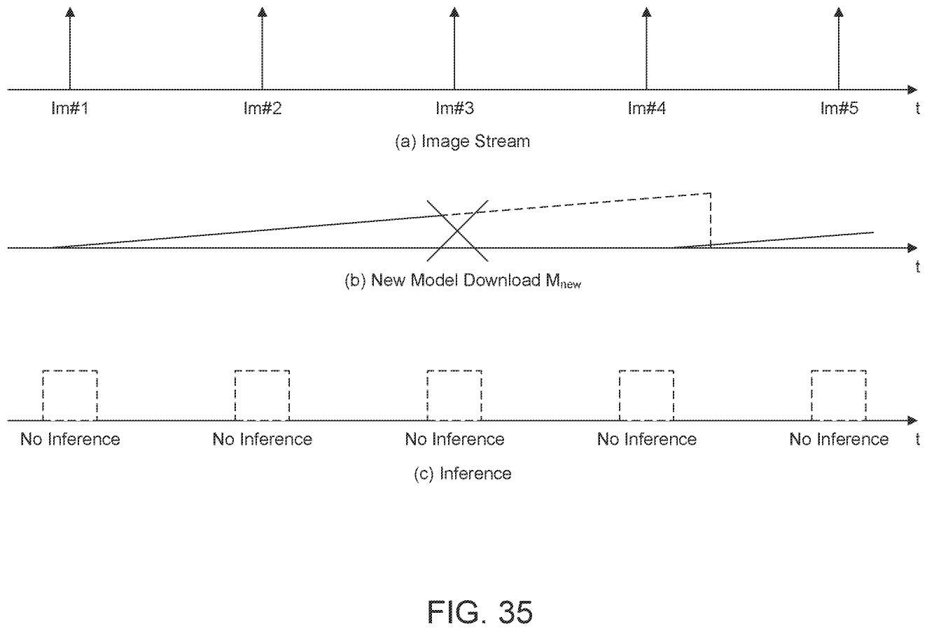

The best result is obtained at 2 Gbit/s with a gain of 47% compare to the base line. FIG. 35 provides some graphical representations of the results. The total time for comparison is the sum of download time, inference time and waiting time. Without the proposed methods (i.e., Baseline), the model is downloaded in one part; with the proposed methods (i.e., Progressive inference), the model is split in several sub parts and each sub part is computed in sequence. Depending on the DL bitrate, different combinations of chunk aggregation enable the reduction of the total time. Best chunk aggregation for each bitrate is shown in the following table.

| | | # | |
|---|---|---|---|
| DL Bitrate | | chunks | Unitary chunk aggregation |
| 10.00 | Mbit/s | 10 | [[0], [1], [2, 3], [4, 5, 6], [7], [8, 9], |
| | | | [10, 11], [12, 13, 14, 15], [16], [17]] |
| 100.00 | Mbit/s | 11 | [[0], [1, 2], [3], [4], [5, 6], [7], [8, 9], |
| | | | [10, 11], [12, 13], [14, 15, 16], [17]] |
| 500.00 | Mbit/s | 9 | [[0], [1, 2], [3], [4, 5], [6], [7, 8, 9, 10, 11], |
| | | | [12, 13, 14], [15, 16], [17]] |
| 1.00 | Gbit/s | 9 | [[0], [1, 2], [3, 4, 5, 6, 7, 8], [9, 10, 11], |
| | | | [12, 13], [14], [15], [16], [17]] |
| 5.00 | Gbit/s | 11 | [[0], [1, 2, 3], [4], [5, 6], [7], [8], |
| | | | [9, 10, 11, 12], [13, 14], [15], [16], [17]] |
| 10.00 | Gbit/s | 13 | [[0], [1], [2, 3], [4, 5], [6], [7], [8], [9], |
| | | | [10, 11], [12, 13, 14], [15], [16], [17]] |

In the following, several AI/ML model split methods are presented to generate model subsets/chunks considering the different model architectures and network conditions. All the embodiments described below aim at palliating the issues that could happen on the wireless link (e.g., interferences, broken link, poor bandwidth) or on the network (e.g., congestion). By splitting the model in many chunks, we increase the probability that the chunks arrive entirely one after the other to their destination and are loaded quickly in memory (which may be costly in time). Each time anew chunk arrives, it enriches the local model and consequently improves the result accuracy.

Note that in the above when the unitary chunk and aggregation chunk are discussed, an aggregation chunk is a subset of the original model but does not generate an inference (final) result, and it uses the intermediate data generated by the previous chunk to infer and generate new intermediate data for the next chunk. This repeats until the last chunk which will generate the final inference result.

In the following, a chunk can be a subset of the original model, once loaded into memory and “plugged” into the previous chunk, it is usable and can provide an inferential (“final”) result.

In an embodiment, the base station 114a controls the activation of the AI/ML model chunks in the UEs by transmitting at least one signaling bit. The Base station monitors the signal quality, in case of degradation, it can decide to trigger the AI/ML inference based on the already downloaded chunks. In that case, the UE initiates inference without waiting reception of further chunks. On the other hand, the measured signal becomes better and better, and predictions show that it shall last a certain duration, in that situation the base station may decide to wait for the complete next chunk download before triggering the AI/ML inference.

In addition, with our techniques the application can use the first loaded chunk and get some inference results very soon comparing to existing download methods.

Troubles on wireless link or on the network are foreseeable. The operators continuously monitor the Access Network, on the other hand the service provider can track whether a user application has difficulties to download services (TCP retransmission). We propose to use such information to decide where to split the model and thus define the chunk size.

In short, the local application can return an inference result faster and does not have to wait for the complete AI/ML model to download. As the AI/ML model continues to download the output result progressively improves. Another advantage of this non-monolithic structure of the model is that in case of multi-connections (e.g., 5G+WiFi), some parts (chunks) are steered toward 5G links and others toward other wireless links (typically WiFi) depending on the steering policy at that time. The AI/ML download can also be more robust to the transport conditions.

FIG. 34 illustrates an example of the problem. In this example, a video application runs on a mobile phone. It relies on an AI/ML model to detect objects. The model requires an update. The new version's size is about 150 MB and the available throughput is about 100 Mbps (13.1 MBps). The model will be fully downloaded in 11 seconds. With a 30 FPS video stream, 366 frames are not processed. Note that in FIG. 34, for ease of illustration, we show that four frames are not processed.

FIG. 35 illustrates another example of the problem. In this example, the upgrade requires an over-the-air downloading operation. Due to the geographic position, to the weather conditions or a bottleneck on the server, the download process goes wrong and is very slow. After some seconds only 10 MB of 120 MB of the whole model have been downloaded. The user decides to stop the download and to re-try.

In another example, a user decides to install a new application on his/her mobile phone. This application relies on an AI/ML model which is very large. At the same time, in the concert hall, many other users do the same thing therefore causing a slow-down of the download process. The user has to wait for the complete download.

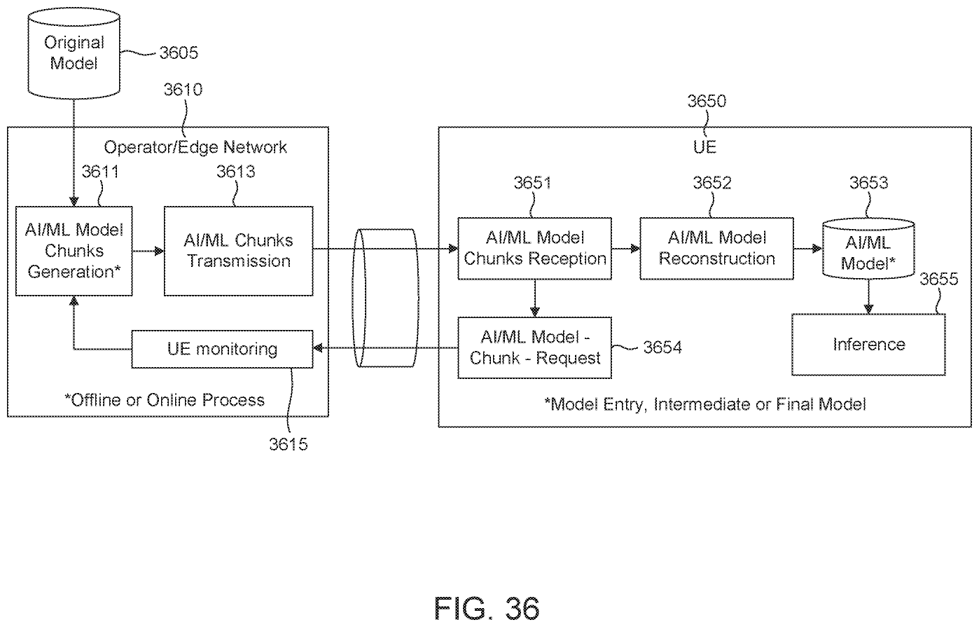

FIG. 36 illustrates an incremental model downloading process, according to an embodiment.

Operator/Edge Network Side (3610)

The server 3610 is a Network Operator or Service Provider entity that is located, for example, in the cloud or at the edge. It embeds the three blocks 3611, 3613 and 3615. Function block 3611 is to determine the best AI/ML model split, to prepare and generate the AI/ML model chunks from the original AI/ML model 3605 as requested by the UE 3650 and based on the information delivered by UE monitoring 3615.

Function block 3615 is to monitor the UE capabilities, i.e., the current memory status, the OS type, the available throughput (downlink) between the operator/Edge Network side 3610 and the UE side 3650. The available throughput may be given by the Operator Core Network function or by the UE itself. Function block 3613 is to transmit to the UE 3650 the chunks as prepared by 3611.

UE Side (3650)

On the UE side 3654, the client or UE device requests an AI/ML model download. Function block 3651 receives the chunks and parses the information it contains: the model it belongs to (baseline model), its type (model entry, intermediate chunk, final chunk), the chunk it is tied to (for example the chunk whose output becomes input of the current chunk). Function block 3652 reconstructs the model with the information given by 3651: Firstly the model entry, which is the light-weight version of the complete model, is copied in memory, then the intermediate chunks, which can be aggregated with previously received chunks to form a more complete version of the model, are copied in memory, and finally the final chunk, which can be aggregated with previously received chunks to form the complete version of the model. Function block 3655 illustrates the inference process. Function block 3655 is operational as soon as the entry model chunk has arrived and is copied in memory. Function block 3654 does the chunk request to the server. The request can provide information on UE characteristics, for example, but not limited to, OS, memory, CPU and GPU.

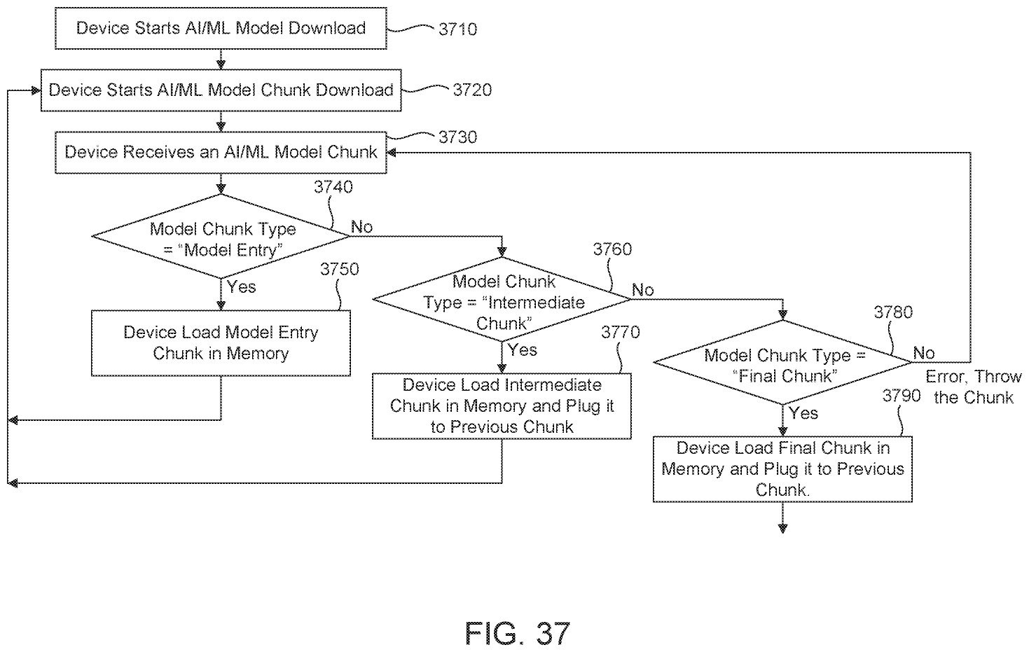

FIG. 37 illustrates an incremental model downloading process at the UE side, according to an embodiment. At step 510, the device needs a new model and requests its download. As a model is composed of several chunks, this step is performed once. This step is performed by block 3654. It can also provide information on UE status to server in this step (RSS, DL throughput, memory available, expected latency to receive model first chunk). Block 3711 in the server can use this information to best select the split options of the AI/ML model.

At step 3720, the model is downloaded in multiple chunks, so this step is repeated several times. Steps 3720 and 3730 perform chunk reception, which can be performed by block 3651. Steps 3750, 3770, 3790 steps are performed by block 3752 (model reconstruction). Each new chunk is “aggregated” to previous ones to form a new version (more complete) of the model. Each version of the “aggregated” chunks is a functional model that is loaded in memory (block 3753) and used for inference (block 3755). Note: the term “aggregation” might not cover all possibilities, for example, when an intermediate chunk is a model itself that will replace the previous one.

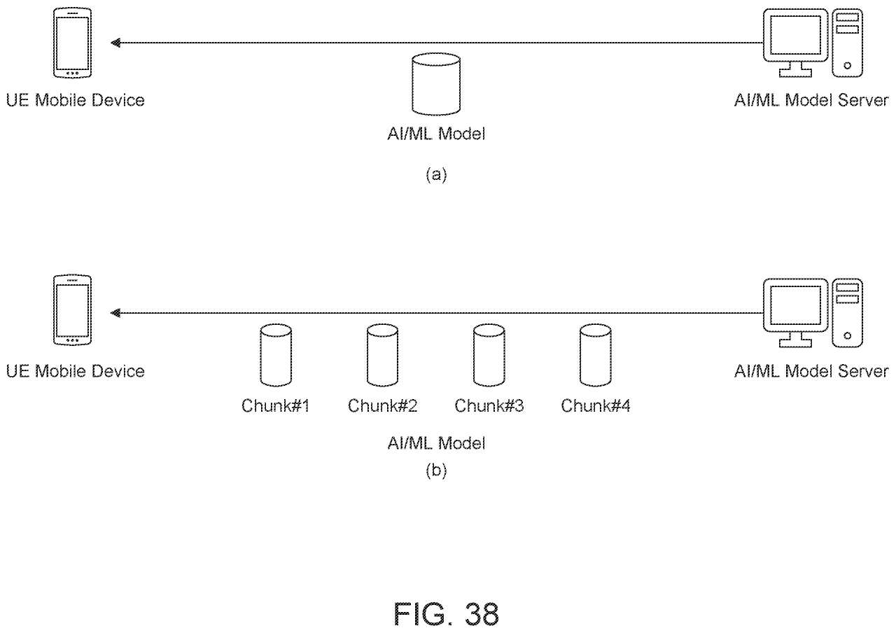

According to the incremental downloading process, the AI/ML model is not seen as a monolithic entity (see FIG. 38(a)), but as an ensemble of several model chunks as shown in FIG. 38 (b).

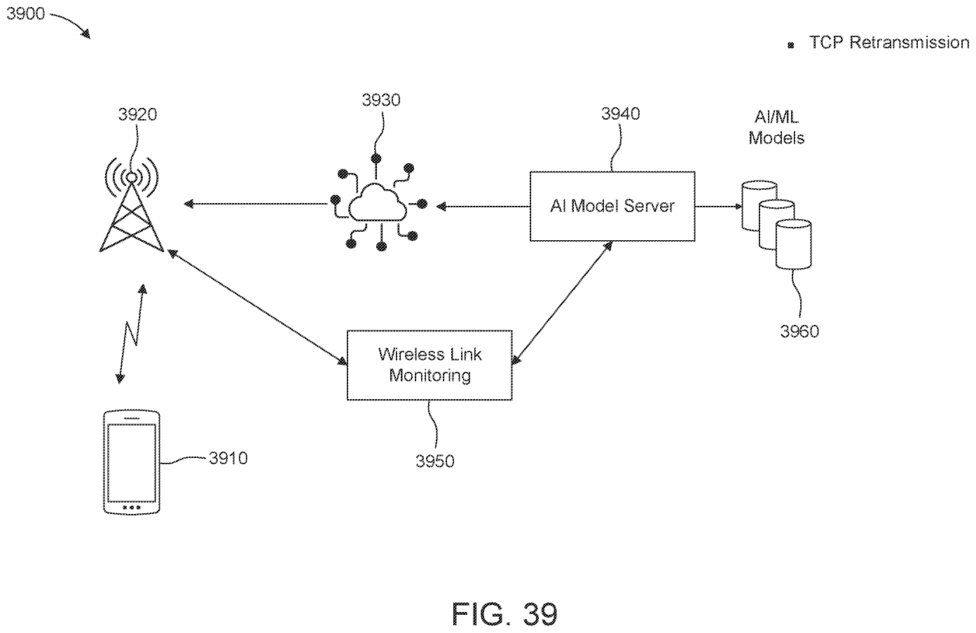

FIG. 39 illustrate a scheme (3900) for download transmission path monitoring, according to an embodiment. In this scheme, a mobile device or UE 3910 communicates with network 3930 via Radio Access Network 3920. An AI model server 3940 manages an AI/ML models database 3960. AI Model server 3940 may embed a functionality that logs the TCP retransmission per UE. A wireless link monitoring functionality 3950 may be provided by the operator itself or that may be part of the UE 3910. It may give information about the link quality or the available throughput between the UE 710 and the Radio Access Network 720.

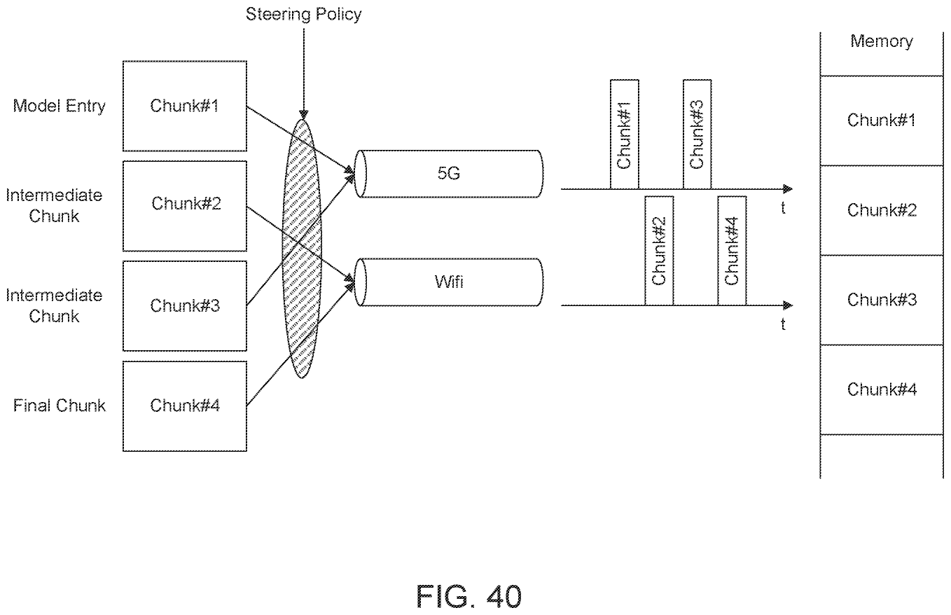

FIG. 40 illustrate an example of multi-connection case, according to an embodiment. In this case the UE is connected to the network and the AI model server via two RAT, NR 5G and WiFi. The application running on the UE has requested an AI/ML model download. On the server side, an AI/ML model split in four chunks is available for download. The network operator is responsible of the traffic steering control and it is up to the operator depending on its steering policy to decide whether chunk #1 has to be routed towards NR 5G or towards WiFi. The steering policy may take into account that chunk #1 packets have a high priority in regard to other subsequent chunks. In that sense, it will route chunk #1 packets to the wireless communication link with a QoS that is stringent in terms of packet error rate or packet delay budget. In the meanwhile, chunk #2 is routed towards the other wireless link, because, as a steering policy example, the available throughput at that time is higher on that link and the QoS is less stringent than with chunk #1. Chunk #3 and chunk #4 will also be routed following the steering policy. This example illustrates the interest of the AI/ML model split when the network operator has to route packets in a multi-connection case. It also illustrates the fact that the network operator has to apply a policy based on the chunk ID. In a variant, the UE (e.g. block 3654) indicates on which RAT it requests the download of a chunk (additional parameter in chunk request).

Split Methods to Generate Chunks of AI/ML Model

In the following, various solutions for the split methods (on how to generate chunks) are presented. First, second and third embodiments are different ways to split neural networks, the fourth embodiment is based on Decision Tree techniques with split procedures. Then a fifth embodiment provides a method in case of memory constraints.

In the first embodiment, the baseline AI/ML model (the model before it is split/cut into chunks) is split based on a model granularity.

In a first proposal, the AI/ML model is split in many chunks that represent sub-parts of the whole AI/ML model that are re-assembled to form the initial model. The work by Adria Ruiz et al., “Adaptative Inference Cost With Convolutional Neural Mixture Models,” available: https://arxiv.org/abs/1908.06694, proposes a framework that first embeds a large number of CNNs that share weights, trains them all and finally removes many networks of that mixture to reduce the computation cost of the inference. Following this approach, our proposal would consist in storing the removed CNNs. As a result, on one hand we have the pruned CNN mixture model and on the other hand the removed CNNs. The pruned CNN mixture model is first transmitted, then the stored CNNs are encapsulated in chunks and transmitted as well. The size of the chunks can be adapted by modulating the pruning ratio.

In a second proposal, a light-weight AI/ML model (compressed using pruning or quantization techniques and retrained) is first downloaded, and quickly useable by the local application. While it is executed, a more complete and larger AI/ML model is downloaded.

Once this is done, the application switches to this new model.

In a third proposal, a light-weight and generic AI/ML model is first downloaded, and quickly useable by the local application. While it is executed, another AI/ML model that is fully adapted to the device is downloading. The adaptation criteria may be, for example, memory space and type, the accelerator type, the camera type, the micro type, the input data type. For example in the work by Ben Taylor et al., “Adaptive Selection of Deep Learning Models on Embedded Systems,” available: https://www.lancaster.ac.uk/staff/wangz3/publications/lctes18.pdf, the authors propose a method to determine which model to use for a given input.

In a second embodiment, the baseline AI/ML model is split based on a layer granularity. The AI/ML model is split in many chunks that represent sub-parts of the whole AI/ML model. The split is following a specific procedure that is based on an Early Exit mechanism (see S. Teerapittayanon et al., “BranchyNet: Fast Inference via Early Exiting from Deep Neural Networks,”. available: http://arxiv.org/abs/1709.01686). The first split corresponds to a first chunk of AI/ML layers that, once downloaded, is useable as is and can give a prediction. As soon as the second chunk arrives, it is plugged to the previously sub-model, this new temporary model is now made of two exits. When the third chunk arrives, it is plugged the same manner which adds a third exit, and so on till the final chunk arrives. The basic idea is based on the fact that easy samples can be classified very early in the neural network with a good confidence score, whereas more difficult samples have to go deeper in the network to exit with a satisfactory score. Some existing work rely on this mechanism to distribute the DNN partitions over the network devices (mobile, edge and cloud) and to reduce costs (for example, latency, processing).

In a third embodiment, the baseline AI/ML model is split based on a sub-layer or parameter granularity. In the work by Jiahui Yu et al., “SLIMMABLE NEURAL NETWORKS,” available: https://arxiv.org/pdf/1812.08928.pdf, the authors propose a structural pruning approach where during training insignificant channels are identified and pruned. By following the same approach, we propose to shrink the network at a certain level, say 25% of the total width. This compact network forms the initial chunk. Then, the channels required to reach a level of 50% are gathered in the intermediate chunk [25,50]. The same method is applied for the ranges [50,75] and [75,100] which is the final chunk.

NestDNN framework as proposed in the article by Biyi Fang et al., “NestDNN: Resource-Aware Multi-Tenant On-Device Deep Learning for Continuous Mobile Vision,” available: https://arxiv.org/pdf/1810.10090.pdf, is another model architecture on which our techniques can be applicable.

Conditional computation is another idea related to Early Exit (see Emmanuel Bengio et al., “Conditional Computation in Neural Networks for Faster Models,” available: https://arxiv.org/pdf/1511.06297.pdf.). However, rather than stopping computation at some point, effectively deactivating subsequent layers, conditional computation deactivates individual neurons in each layer.

In a fourth embodiment, the ML model is a Decision Tree architecture model, the split is based on branch granularity.

The fifth embodiment illustrates a way to palliate a temporary lack of memory resources of the UE.

In the following, these embodiments are described in more detail. For each of those embodiments there is a different AI/ML model architecture and as mentioned above the goal is to split the AI/ML model into several chunks with a variety of sizes in order to get as soon as possible an AI/ML model operational and to adapt to the wireless conditions. The first chunk that we named “model entry” or “primary chunk” is the main one. It can be seen as a sub-model in the sense that once downloaded it will deliver inference results that are not optimal compared to what a complete model could output. The size of the chunk will depend greatly on the model architecture, but also on the expected accuracy and the transmission conditions. With a poor wireless link, it is wise to have a small “entry model”.

Each chunk will contain a brief description of one or more of the following:
the chunk it is tied to
its type: model entry or primary chunk, additional chunk (intermediate chunk or final chunk)
the total number of chunks for that model and the chunk index, e.g., total_number=7, chunk_index=2
the baseline model identifier (an ID to group chunks of the same model together).
   All the information is required to reconstruct the complete model.

### First Embodiment

Convolutional Neural Mixture Model (CNMM)

As described in an article by Adria Ruiz et al., “Adaptative Inference Cost With Convolutional Neural Mixture Models,” available: https:/arxiv.org/abs/1908.06694, a Convolutional Neural Mixture Model (CNMM) defines a distribution over a large number of CNNs (Convolutional Neural Networks). The mixture is naturally pruned by removing networks with low probabilities.

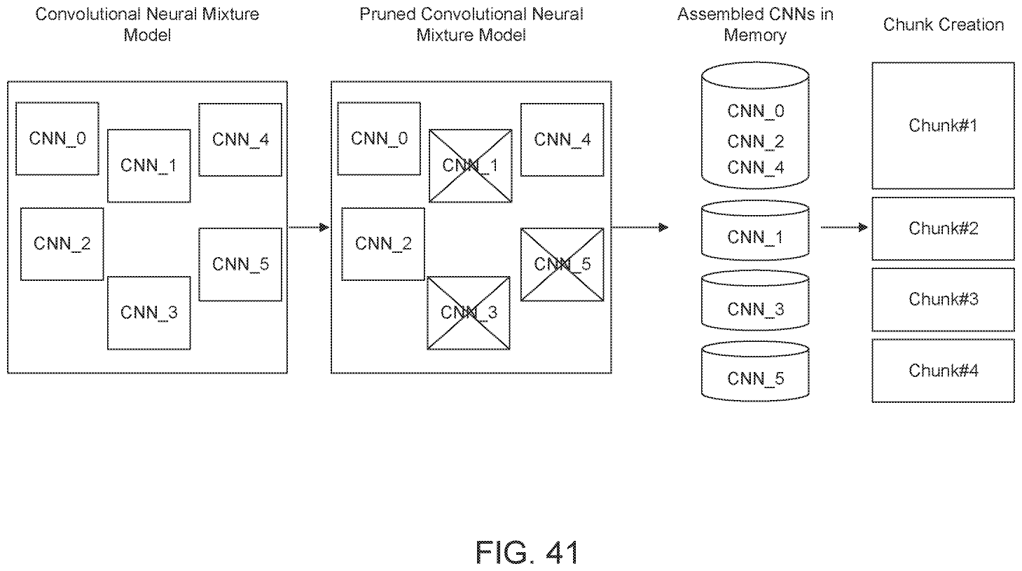

FIG. 41 shows a method of generating the chunks from a CNNs mixture model, according to an embodiment. As mentioned above, instead of getting rid of the removed CNNs (CNN_1, CNN_3 and CNN_5 in the example), we stored them (all of them or the most relevant ones) temporarily. The remaining and relevant CNNs (CNN_0, CNN_2 and CNN_4) are assembled to form the base CNMM model that is the chunk #1. Then chunk #2 is created from the stored CNN_1, chunk #3 from CNN_3 and chunk #4 from CNN_5. We illustrate this method with single CNNs in intermediate chunks, but such a chunk can contain several CNNs. CNMM encodes the mixture of CNNs efficiently by reusing layers between CNNs, so sending just one layer is sufficient to add several CNNs to the mixture.

Network pruning as defined in the CNMM consists in removing networks with a low probability. We propose to weight this probability factor with an additional criterion in relation with the current wireless link conditions (from network operator RAN monitoring, available throughput) and/or the previous downloads (e.g., TCP retransmissions logged by the Service Provider). For example, if the transport condition is bad, the probability is increased so that more networks are removed, and the initial chunk is therefore smaller. Thus, the better are the transport conditions, the less it affects the pruning method and the chunk #1 is closer to the regular size. At the opposite, if the conditions are bad, it is likely that more CNNs are discarded, and even not transmitted, with chunk #1 as small as possible.

Regular DNN Model

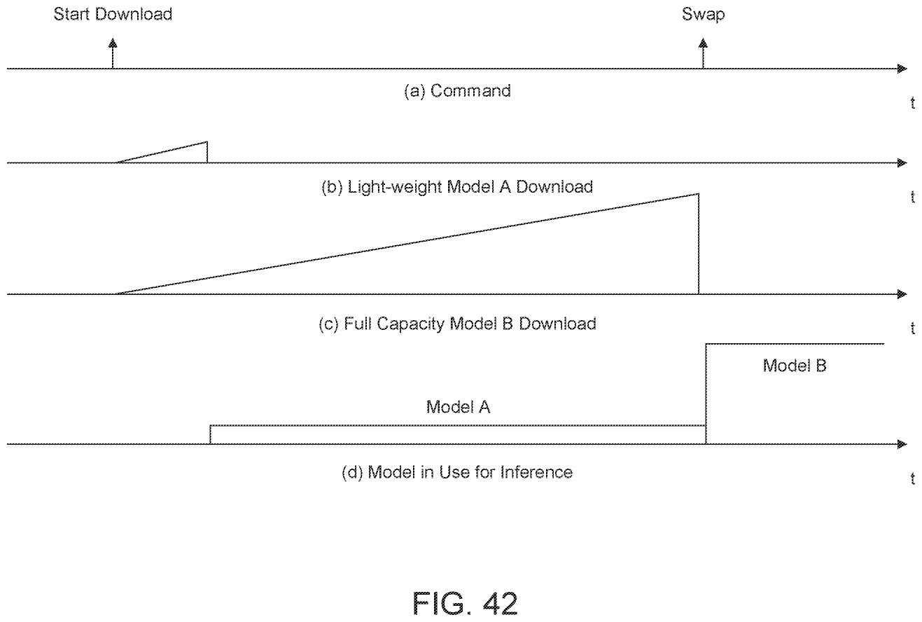

As stated above and described in FIG. 42, a first light-weight AI/ML model is first downloaded. Many compression techniques like pruning and/or layer skipping have been used to have this small size model which is retrained, the counterpart is less accuracy at the model output. But due to its limited size, it is quickly downloaded, copied in memory and operational. The compression ratio is not fixed but on the contrary adaptable. The decision upon the ratio will depend on the current wireless link conditions (network operator RAN monitoring) and/or the previous downloads (TCP retransmissions logged by the Service Provider) as illustrated in FIG. 39.

Another model which is much larger and generates much more accurate inference results is at the same time downloaded. Its larger size (more layers/weights, less quantization) makes that it will take longer before it is fully downloaded. While it is loaded the light-weight model is in charge to deliver the inference results.

KNN and Premodel Architecture

The next solution proposal is based on the work by Ben Taylor et al., “Adaptive Selection of Deep Learning Models on Embedded Systems,” available: https://www.lancaster.ac.uk/staff/wangz3/publications/lctes18.pdf. This solution is based on a series of k-Nearest Neighbour (KNN) classification models. From the image at input, some features are extracted to make a prediction that is then used to select the proper image classification model. The model selection is based on the model input and the precision requirement. They also propose other criteria among which is the model size.

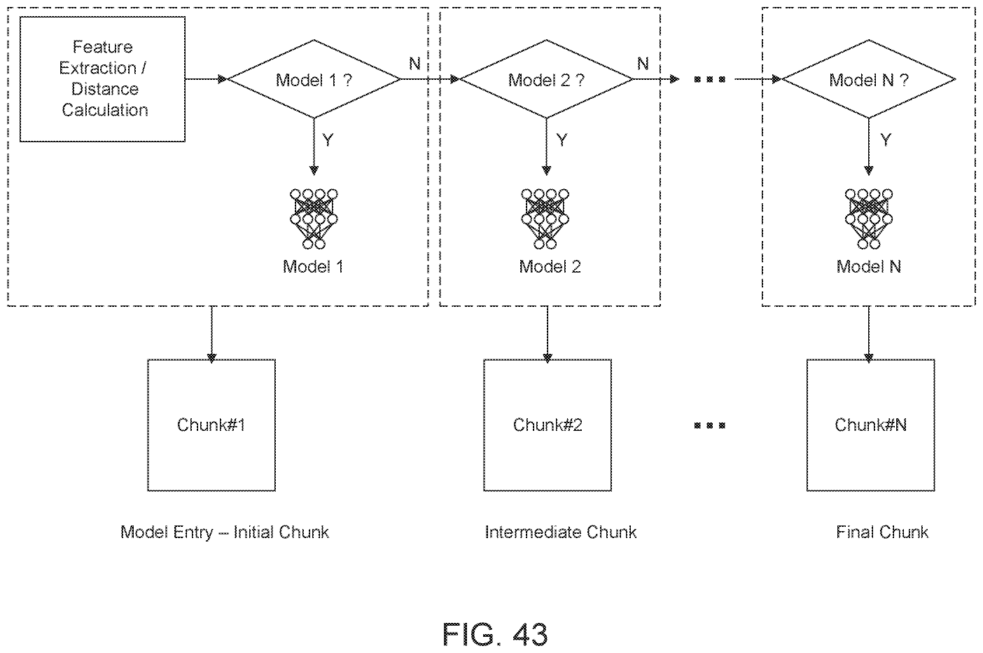

FIG. 43 illustrates a solution to split this architecture, according to an embodiment. Our approach suggests having a compressed model version for the first chunks in order to quickly have an operational model. We also propose to make the model compression ratio dependent on the wireless link conditions and/or the previous downloads as described in the previous solution proposal. There are several possibilities to compress neural networks, for example, pruning or quantization. It is possible to adjust the size of the compressed model compared to its uncompressed size; this is what we call compression ratio. We want the compression ratio to increase if there is a degradation of the transport conditions, and we want a smaller model if the conditions are bad.

Network Solution

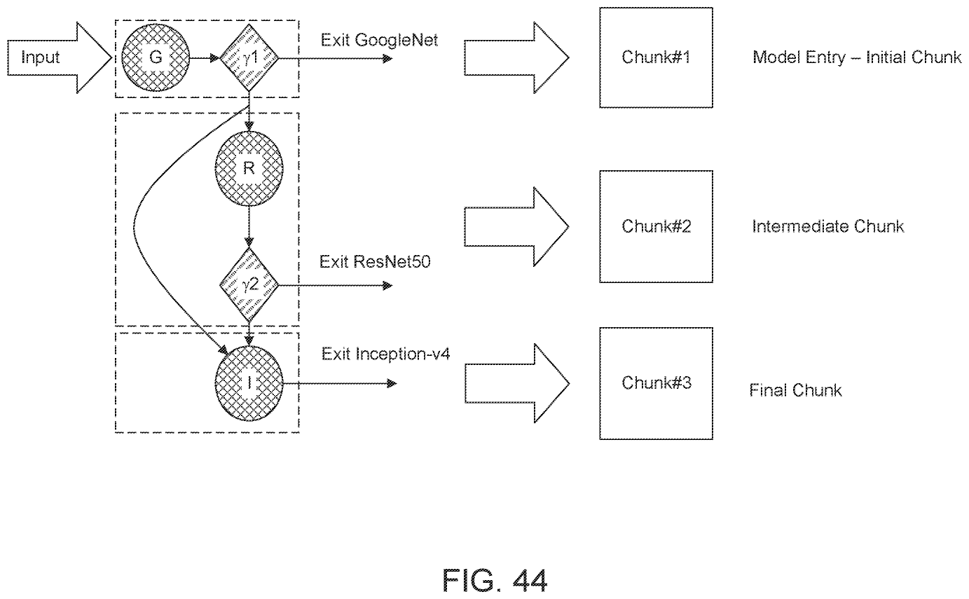

The work by Tolga Bolukbasi et al., “Adaptive Neural Networks for Efficient Inference,” available: https://arxiv. org/pdf/1702.07811.pdf proposes another network selection architecture. In this approach, the pre-trained DNN models A (AlexNet), G (GoogleNet) and R (ResNet) have all a different cost/accuracy trade-off, the cheapest model is arranged first and the most expensive one last. Indeed, the AlexNet model is more accurate than GoogleNet and ResNet but it is very large, 60 M parameters and respectively 4 M and 25.6 M for GoogleNet and ResNet50. More generally, we can use other models different from AlexNet, GoogleNet or ResNet. FIG. 44 illustrate the same approach and with a proportional accuracy/size trade-off and possible chunk construction. GoogleNet (G) should return less accurate results, then ResNet50 (R) and finally Inception-v4 (I), with 35 M parameters.

### Second Embodiment

Early-Exit Based Solution (BranchyNet)

The AI/ML model is structured with various exits points. The Early-exit technique is a well-known method to output results with a low latency for the first exits and a higher latency but higher accuracy for the next ones. It prevents the data from going through the whole model if the confidence score is above a threshold.

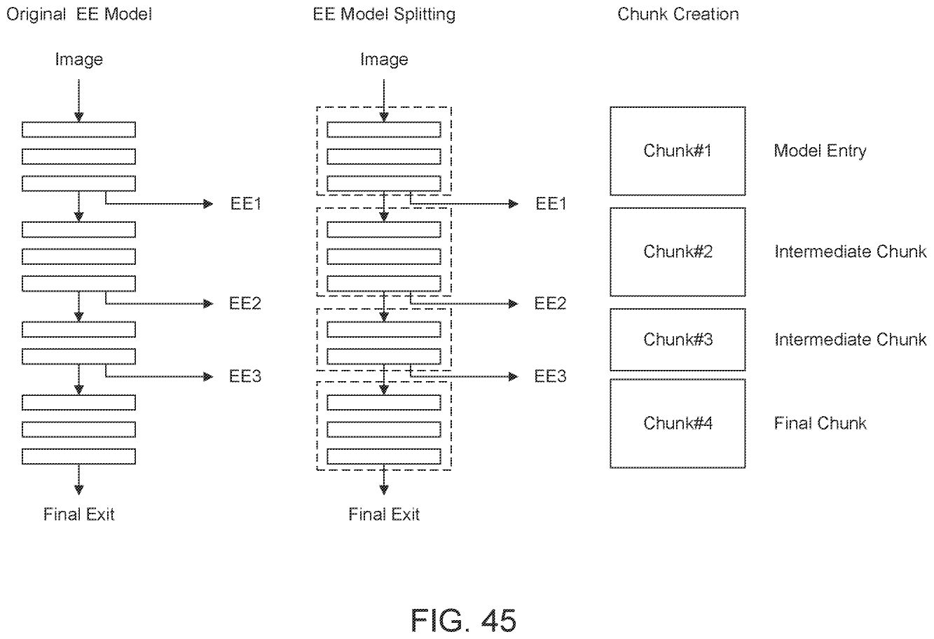

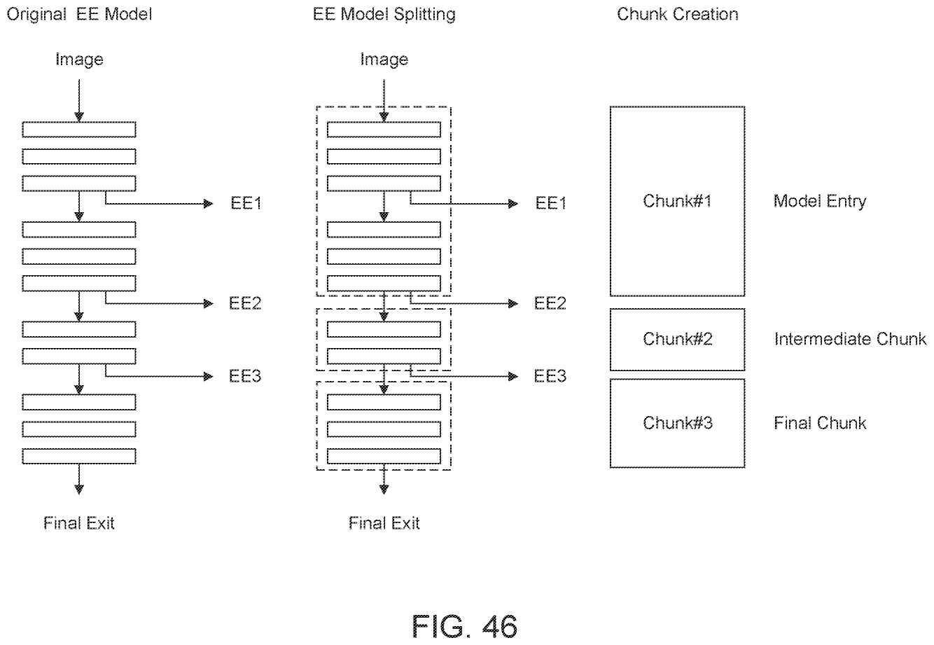

FIG. 45 illustrates a method where the split is performed at the Early-Exit (EE) stage, according to an embodiment. In this split configuration, 4 chunks are created. In the next split configuration as illustrated in FIG. 46, only 3 chunks are created. The decision where to apply the split is taken based upon:
The current wireless link conditions (network operator RAN monitoring, available throughput).
The previous downloads (TCP retransmissions logged by the Service Provider).

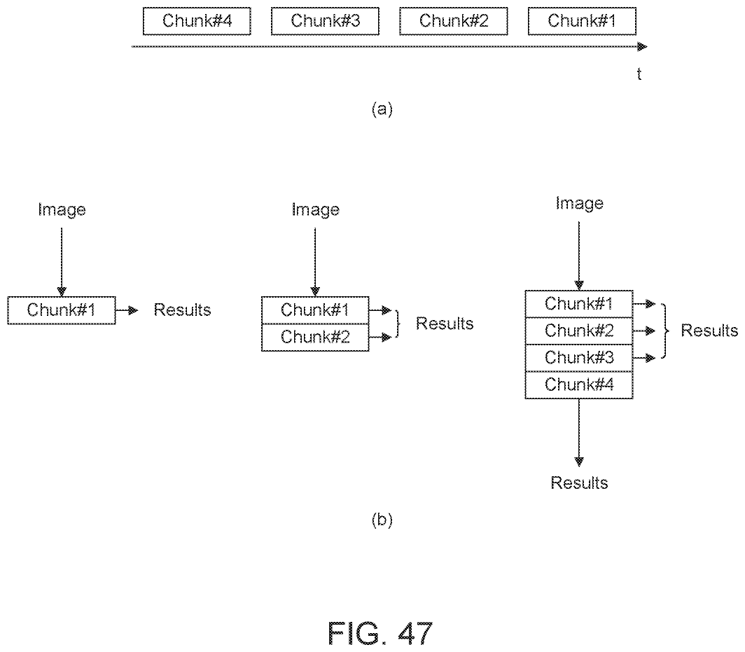

FIG. 47 illustrates an example of chunk transport and reassembling. In this example, chunks arrive at the client side. Chunk #1 arrives first.
Chunk #1 is described as a “model entry,” it is loaded in memory and ready for execution.
Next chunk (chunk #2) is not arrived yet, the application relies on current model status(=chunk #1) to output results.
Chunk #2 arrives, it is described as an “intermediate chunk,” it is loaded in memory and plugged (the output of chunk #1 becomes the input of chunk #2) to chunk #1. The application relies now on model (=chunk #1+chunk #2) to output results as long as chunk #3 is not arrived.
Chunk #3 and chunk #4 arrive. Chunk #3 is described as “intermediate chunk” and chunk #4 as “final chunk.”
Chunk #3 is loaded in memory and plugged to chunk #2.
Chunk #4 is loaded in memory and plugged to chunk #3 and ready for execution.
The whole model is now reconstructed and operational.

Early-Exit Based Solution (Adaptive Neural Network)

Very similar to the Early Exit mechanism, the work by Tolga Bolukbasi et al., “Adaptive Neural Networks for Efficient Inference,” available: https://arxiv.org/pdf/1702.07811.pdf have described another approach. In particular, before each expensive neural network layer (e.g. Convolutional Layers), they train a policy that determines whether the current sample should proceed to the next layer or be diverted to a simple classifier for an immediate classification.

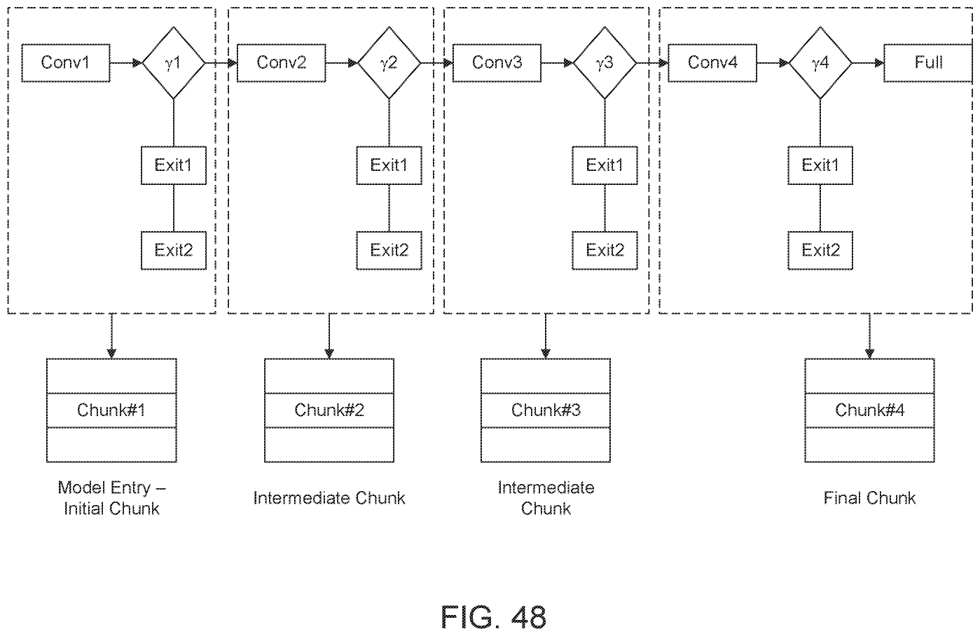

FIG. 48 illustrates a split example, which is very similar to the previous Early Exit architecture.

### Third Embodiment

Slimmable Neural Networks

In this proposal, the device will use a sequence of compressed models. Each model will be constructed from the previous model and a new model chunk.

This solution can for example be based on the slimmable neural networks as proposed in an article by Jiahui Yu et al., “SLIMMABLE NEURAL NETWORKS,” available: https://arxiv.org/pdf/1812.08928. pdf.

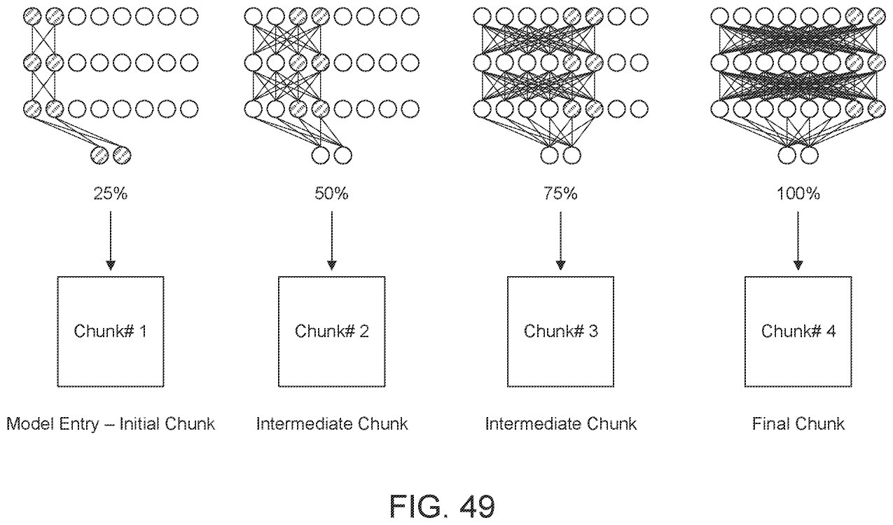

In this solution, the same model can run at different widths, which are basically the number of active channels. The primary idea of this technique is to have an adaptive trade-off between accuracy and efficiency. As illustrated in FIG. 49, our proposal consists in reusing this technique to first transport a shrunk version of the model, say shrunk at 25%, and to send the next channels range by range, [25,50], [50,75] and [75,100]. 25% is an example of ratio that is applicable. This ratio could be smartly adapted to the current wireless link conditions (network operator RAN monitoring, available throughput) and/or to the previous downloads (TCP retransmissions logged by the Service Provider).

Alternatively, the compression can rely on quantizing the weights. So, for example, the initial chunk contains the model architecture and one (or some) bit(s) per model parameter, and each following chunk adds one (or some) bit(s) to each model parameter. For instance 8 most significant bits for the initial chunk, 8 bits more for the second chunk to reach a 16 bits accuracy, 16 bits more for the third chunk to reach 32 bits and then 32 bits more to reach 64 bits.

NestDNN Based Solution

Besides the Early Exit mechanisms, this approach is also applicable to another type model architecture called NestDNN, as described in an article by Biyi Fang et al., “NestDNN: Resource-Aware Multi-Tenant On-Device Deep Learning for Continuous Mobile Vision,” available: https://arxiv. org/pdf/1810.10090.pdf.

NestDNN employs a model pruning and recovery scheme which transforms a deep learning model into a single compact multi-capacity model. The pruning method here is applied on filters, which have different capacities. For example, capacity #1 to reduce memory footprint and computation time, and capacity #2 when memory and computation resources are back to normal or at least less constrained. We propose to rely on this filter characteristic to fit the chunks.

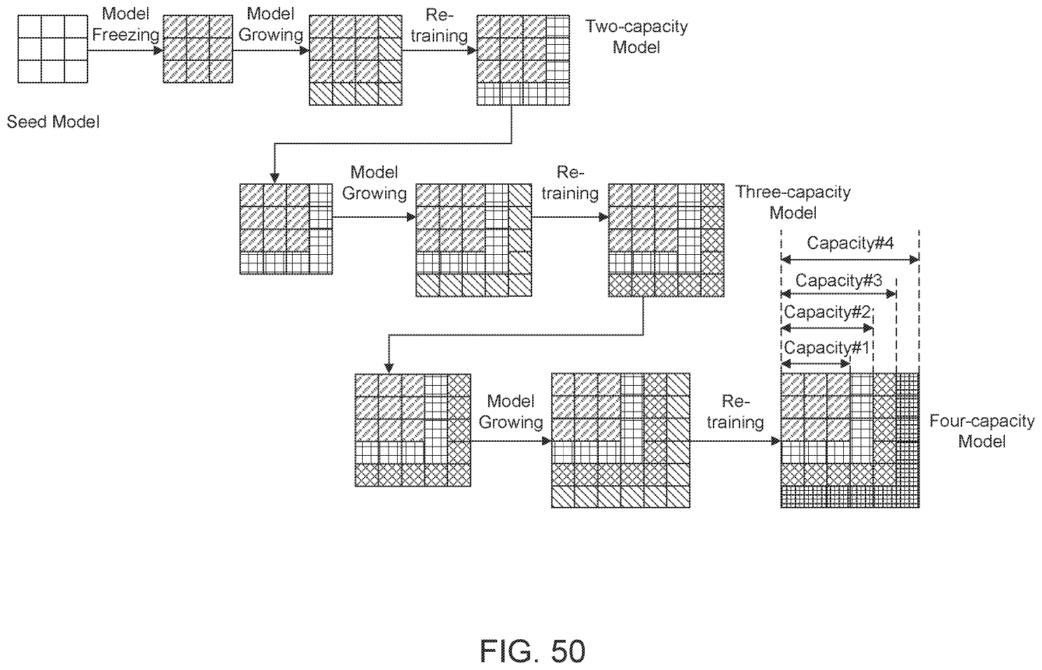

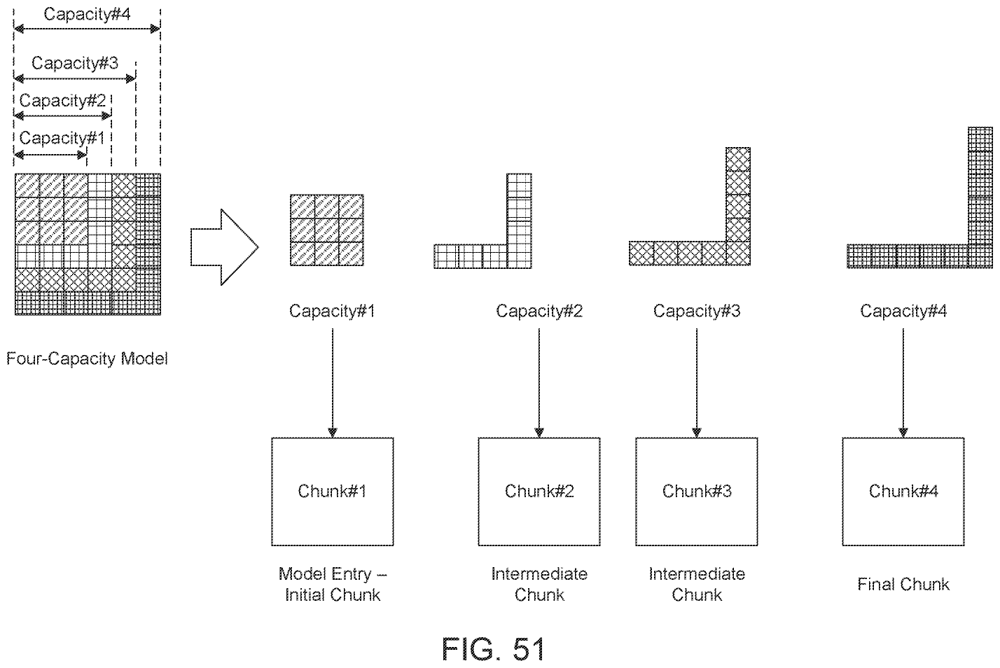

FIG. 50 illustrates that NestDNN is applied to generate a four-capacity model. FIG. 51 illustrates that the four-capacity model is broken down in four portions that are mapped onto four different chunks.

Conditional Computation-Based Solution

In an article by Emmanuel Bengio, “Conditional Computation in Neural Networks for Faster Models,” available: https://arxiv.org/pdf/1511.06297.pdf, the authors propose to use conditional computation to adaptively compute only some neurons in each layer, depending on the output of the previous layer.

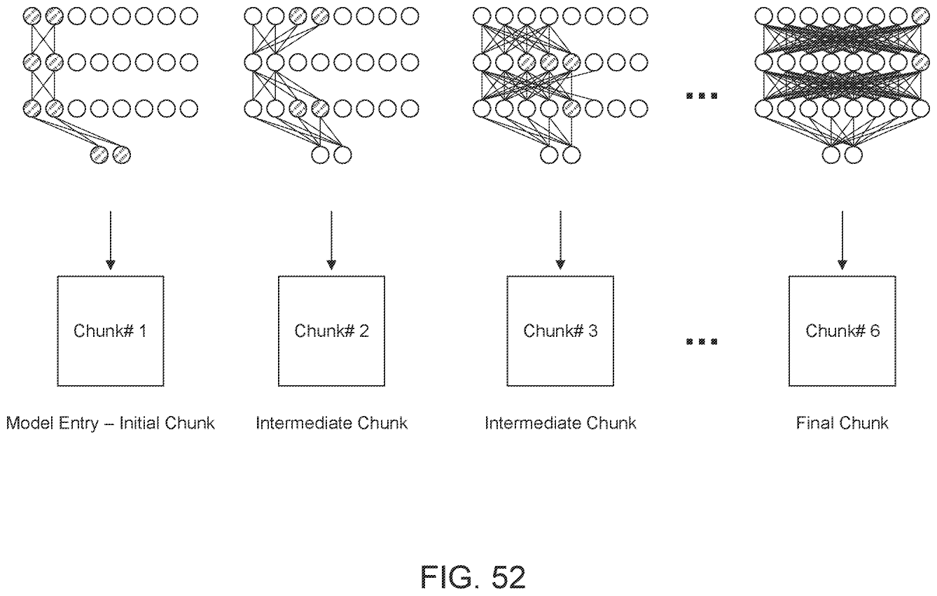

This leads to an embodiment of the approach based on early exit. In this embodiment, rather than a set of layers, each chunk can contain some neurons of some layers and the associated parameters. This is illustrated in FIG. 52.

The decision of how the chunks should be constructed can be based on:
The current wireless link conditions (network operator RAN monitoring, available throughput),
The previous downloads (TCP retransmissions logged by the Service Provider), and/or
The last or current input seen by the model.

If the decision depends on the input, it can be either taken by the device (which sends the reference of the neurons to be included in the next chunk to the server) or by the server (the device must first send the input to the server).

### Fourth Embodiment

Decision Tree

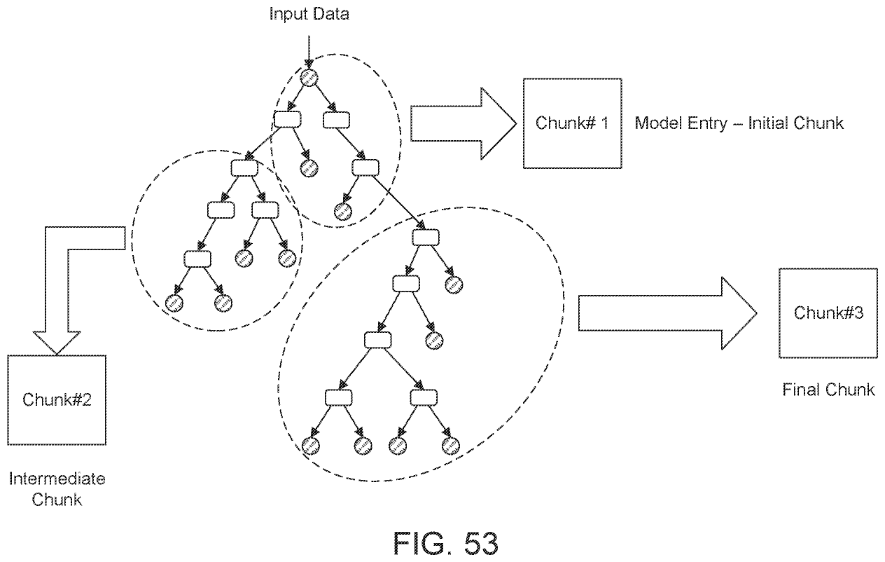

FIG. 53 illustrates a Decision Tree model with a split proposal where the root node as model entry is part of the chunk #1. Then, intermediate chunks and final chunk will contain sub-branches stemmed from the decision tree split.

### Fifth Embodiment

At a given point in time, the client, say a UE device, sends a chunk request based on its current memory status (e.g. GPU). Given the type of model requested by the UE, to the available throughput and to the UE memory status, the server plans to deliver the model with five chunks.

In one example, the server delivers chunk #1 that fits the UE memory requirements. The UE receives chunk #1 and copies it into memory. The same applies with chunk #2. Now both chunk #1 and chunk #2 are copied in memory and useable as is by the application. The model is not completed yet, there are still missing chunks, chunk #3, chunk #4 and chunk #5. The server transmits them.

But the UE GPU memory is now almost full because another application has started in the meanwhile, which prevents new chunks from being loaded into memory. As a consequence, the coming chunks, chunk #3, chunk #4 and chunk #5 are dropped and the application work with model made of {chunk #1+chunk #2}.

More generally, an application requests an AI/ML model based on memory resources at a given point in time. While the initial chunks are received and copied in memory, the remaining chunks are transmitted. During this transmission period, the UE memory resources change, which may lead to a lack of memory space. In that case, all subsequent chunks are discarded.

This embodiment shows that our method can palliate a lack of memory resources (temporary or not). If the memory resources increase again the UE may request the next additional chunks. This makes the model adaptable to the UE memory status.

Systems and methods for processing data according to representative embodiments may be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within a robotic assistance/apparatus (RAA) and/or another mobile device remotely. In the later a case, data may be transferred via wireline or wirelessly between the RAA or other mobile device containing the sensors and the remote device containing the processor which runs the software which performs the scale estimation and compensation as described above. According to other representative embodiments, some of the processing described above with respect to localization may be performed in the device containing the sensors/cameras, while the remainder of the processing may be performed in a second device after receipt of the partially processed data from the device containing the sensors/cameras.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods. It should be understood that the representative embodiments are not limited to the above-mentioned platforms or CPUs and that other platforms and CPUs may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1B.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mate-able and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Throughout the disclosure, one of skill understands that certain representative embodiments may be used in the alternative or in combination with other representative embodiments.

1. A method implemented by a server, comprising:
receiving information indicating a request for an artificial intelligence and/or machine learning (AI/ML) model, wherein said information is received from a client device via any of wired and wireless communication;
partitioning said AI/ML model into a plurality of sub-parts;
forming a set of aggregation chunks based on (i) a first time period corresponding to an amount of time for said client device to obtain said set of aggregation chunks from said server and (ii) a second time period corresponding to an amount of time for said client device to make inferences on said set of aggregation chunks, each aggregation chunk corresponding to one or more sub-parts of said plurality of sub-parts; and
transmitting said set of aggregation chunks to said client device.

2. (canceled)

3. The method of claim 1, wherein said first time period is based on a size of said set of aggregation chunks and a bitrate.

4. The method of claim 1, wherein said set of aggregation chunks comprises a first aggregation chuck to be transmitted first in time, and wherein said first aggregation chunk is usable for generating (i) an inference without using other aggregation chunks of the set of aggregation chunks, (ii) an intermediate result without using said other aggregation chunks, or (iii) an intermediate result with previous intermediate result without using other aggregation chunks.

5. (canceled)

6. The method of claim 1, wherein each sub-part corresponds to one or more neural network layers.

7. The method of claim 1, further comprising:
adjusting said set of aggregation chunks, at least one of updated first time period and updated second time period.

8. The method of claim 1, further comprising:
forming different combinations of sub-parts; and
selecting one of said combinations to form said set of aggregation chunks.

9. (canceled)

10. The method of claim 1, wherein each aggregation chunk includes one or more of the following:
a first identifier (ID) of that aggregation chunk,
a second ID of a preceding aggregation chunk that a current aggregation chunk is tied to,
a chunk type indicating whether a current aggregation chunk is a model entry, an intermediate chunk, or a final chunk of said AI/ML model,
a total number of aggregation chunks in said AI/ML model,
a chunk index of a current aggregation chunk,
a size of said current aggregation chunk,
an expected inference time of said current aggregation chunk on one or more target client devices,
a reference bitrate,
a reference device profile, and
a baseline model identifier.

11. The method of claim 1, wherein said AI/ML model is a convolutional neural mixture model, and wherein said AI/ML model is partitioned into a pruned convolutional neural network mixture model and (ii) one or more removed convolutional neural networks.

12-14. (canceled)

15. A method; implemented by a wireless transmit/receive unit (WTRU), comprising:
transmitting a request for a chunk that is part of an artificial intelligence and/or machine learning (AI/ML) model, wherein said information is transmitted from said WTRU to a server via any of wired and wireless communication;
receiving said chunk from said server;
generating a first inference or intermediate result from said chunk;
receiving, from said server, a subsequent chunk that is also part of said AI/ML model; and
generating an inference result based on said first inference or intermediate result and said subsequent chunk, wherein receiving said subsequent chunk and said generating first inference or intermediate result are performed in parallel.

16. The method of claim 15, wherein generation of said first inference or intermediate result from said chunk starts as soon as said chunk is received.

17. The method of claim 15, further comprising deleting said chunk after said first inference or intermediate result is generated.

18. The method of claim 15, further comprising:
reevaluating at least one of (i) a first time period corresponding to an amount of time for said WTRU to obtain said chunk and (ii) a second time period corresponding to an amount of time for said WTRU to make inferences on said chunk; and
requesting said server to adjust how chunks are generated.

19-20. (canceled)

21. An apparatus comprising a server, the server comprising circuitry, including a transmitter, a receiver, a processor and memory, configured to:
receive information indicating a request for an artificial intelligence and/or machine learning (AI/ML) model, wherein said information is received from a client device via any of wired and wireless communication;
partition said AI/ML model into a plurality of sub-parts;
form a set of aggregation chunks based on (i) a first time period corresponding to an amount of time for said client device to obtain said set of aggregation chunks from said server and (ii) a second time period corresponding to an amount of time for said client device to make inferences on said set of aggregation chunks, each aggregation chunk corresponding to one or more sub-parts of said plurality of sub-parts; and
transmit said set of aggregation chunks to said client device.

22. The apparatus of claim 21, wherein each sub-part corresponds to one or more neural network layers.

23. The apparatus of claim 21, wherein said server is further configured to:
adjust said set of aggregation chunks, based on at least one of updated first time period and updated second time period.

24. The apparatus of claim 21, wherein said server is further configured to:
form different combinations of sub-parts; and
select one of said combinations to form said set of aggregation chunks.

25. The apparatus of claim 21, wherein said AI/ML model is a convolutional neural mixture model, and wherein said AI/ML model is partitioned into a pruned convolutional neural network mixture model and (ii) one or more removed convolutional neural networks.

26. A wireless transmit/receive unit (WTRU), comprising circuitry, including a transmitter, a receiver, a processor and memory, configured to:
transmit a request for a chunk that is part of an artificial intelligence and/or machine learning (AI/ML) model, wherein said information is transmitted from said WTRU to a server via any of wired and wireless communication;
receive, from said server, said chunk and a subsequent chunk that is also part of said AI/ML model;
generate a first inference or intermediate result from said chunk; and
generate an inference result, based on said first inference or intermediate result and said subsequent chunk, wherein (i) receiving said subsequent chunk and (ii) said generating first inference or intermediate result are performed in parallel.

27. The WTRU of claim 26, wherein said first time period is based on a size of said chunk and a bitrate.

28. The WTRU of claim 26, wherein said AI/ML model is a convolutional neural mixture model, and wherein said AI/ML model is partitioned into a pruned convolutional neural network mixture model and (ii) one or more removed convolutional neural networks.
